(19) United States
(12) Patent Application Publication
(10) Pub. No.: US 2022/0174783 A1
(43) Pub. Date: Jun. 2, 2022

(54) METHOD AND DEVICE FOR WIRELESS COMMUNICATION

(71) Applicants: Yu CHEN, SHANGHAI (CN); Xiaobo ZHANG, SHANGHAI (CN)

(72) Inventors: Yu CHEN, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/536,075

(22) Filed: Nov. 28, 2021

(30) Foreign Application Priority Data
Nov. 30, 2020 (CN) 202011370801.9

(51) Int. Cl. H04W 80/02; H04W 4/06; H04W 40/24

(52) U.S. Cl. CPC H04W 80/02; H04W 12/108; H04W 40/24; H04W 4/06

(57) ABSTRACT

A method and device for wireless communications, including receiving a first message group and a first MAC PDU group, the first message group indicating a first new source ID and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU; transmitting a second MAC PDU group; the second MAC PDU group comprises a second adaptation layer PDU; The present disclosure assists the first node in determining a source or destination UE ID properly, thus enhancing security and privacy.

### CROSS REFERENCE TO RELATED APPLICATIONS

This application claims the priority benefit of Chinese Patent Application No. 20201137080.9, filed on Nov. 30, 2020, the full disclosure of which is incorporated herein by reference.

### BACKGROUND

### Technical Field

The present disclosure relates to transmission methods and devices used in wireless communication systems, and in particular to a transmission method and device in wireless communications for reducing traffic interruption, enhancing traffic continuity and better safeguarding security and privacy during employment of the relay.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum, and lower traffic interruption and call drop rate, higher security and privacy and support to lower consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non Terrestrial Network (NTN) and Terrestrial Network (TN), Dual connectivity system, or combined, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. Information can also be forwarded through relaying to expand the network coverage and improve the system reliability.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

### SUMMARY

In various communication scenarios, the inter-UE communication scenario relates to reliable link establishment and maintenance, the address management and configuration, inter-layer coordination and the issue of security arising therefrom. Due to the lack of central node management in the inter-UE communication, especially in communications out of coverage of a serving cell, the authentication between these two UEs is more likely to be threatened, especially when a listener is able to track unencrypted parameters sent by the UE, such as fields in a header of an unencrypted PDU which are indicating user IDs, thus threatening the privacy. Therefore, a feasible solution is proposed to update parameters of the UEs in a periodical manner or at intervals, including information of the UE's ID and security algorithm. In the parameter updating, any inappropriate processing will probably allow a listener to infer updated information from previously obtained information, thus raising the chance of security threat against users. For example, a listener usually spends a long time tracking and requires a large amount of calculation before cracking an encrypted key, the longer the tracking, the higher possibility of the deciphering. If the listener is able to infer new information from old information or associate them, which to some extent means that the UE fails to be updated effectively, there will be a drastic increase of security threat to the user as time passes by. For another example, with the hope of acquiring a user's whereabouts, a listener, if it is still possible for it to associate IDs before and after updating, will have a better knowledge of the user's traces. For those inter-UE communications where relay is still employed, the problem becomes more severe, because if IDs respectively associated with each link cannot be updated synchronously, the listener will readily associate not-yet-updated ID with already-updated ones to possess the new IDs, and the coordination between nodes will add even more complexity to the above issue. Particularly, with the update of parameters of a first hop being completed, there are still at least partial parameters of a second hop not updated and the second hop still needs to use some parameters of the first hop, the difficulties and risks facing user privacy and security will just increase. These are all issues that remain to be handled in inter-UE communications, particularly in sidelink communications.

To address the above problem, the present disclosure provides a solution.

It should be noted that if no conflict is incurred, the embodiments of any node in the present disclosure and the characteristics in the embodiments can be applied to any other node, and vice versa. And the embodiments in the present disclosure and characteristics in the embodiments can be mutually combined if there is no conflict.

The present disclosure provides a method in a first node for wireless communications, comprising:

receiving a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

transmitting a second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, a problem that remains to be solved in the present disclosure comprises: when a source UE and a destination UE are in communication via a relay node, there are two hops in the communication, with two sidelink unicast links respectively involved in one hop from the source UE to the relay and the other from the relay to the destination UE; considering privacy protection, each unicast link will update its parameters on a regular basis or according to a higher-layer indication, including link layer ID, application layer ID, IP address or other parameters, especially parameters relating to identification. A PDU delivered in each hop comprises both a link layer ID and an ID/IDs in a newly introduced adaptation layer, which include a source UE ID and/or a destination UE ID. When a source UE of the first hop updates its link layer ID, its source ID is updated as well, and the source ID will be utilized in an adaptation layer of the second hop, at that time, a link layer ID of the second hop may not be updated, so, if the relay node uses the updated source ID immediately in the second hop, the new source ID and the old link layer ID of the second hop will be likely to be transmitted together; after the link layer ID of the second hop is updated, the new source ID and the new link layer ID of the second hop will be likely to be transmitted together, which enables the listener to associate the new and old link layer IDs of the second hop through the updated source ID, thus making the link layer ID update of the second hop meaningless, and bring the risks of privacy protection.

In one embodiment, advantages of the above method include: supporting mutually independent link layer ID updates of the two hops to the greatest extent; after the first hop determines a new ID to be used in an adaptation layer, how to use such ID will be dependent on the usage of the link layer ID of the second hop, so as to ensure the unity of ID updates of the second hop. What should be noted is that a source and a destination are mutually deemed as transceivers when in communications, namely, each UE can be seen as a relative source UE or a relative destination UE; therefore, the above method is in any case applicable to the first hop and the second hop.

Specifically, according to one aspect of the present disclosure, the third field in a header of the first adaptation layer PDU comprises the first new source ID, and a fourth field in a header of the first adaptation layer PDU comprises a first new destination ID;

when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID.

Specifically, according to one aspect of the present disclosure, receive a first signaling and a third MAC PDU group; the first signaling indicates the first old source ID and a second old source ID; the first field in a MAC Header of any MAC PDU in the third MAC PDU group comprises at least part of bits in a first old ID; the second field in a MAC Header of any MAC PDU in the third MAC PDU group comprises at least part of bits in a second old ID; the third MAC PDU group comprises a third adaptation layer PDU; when a header of the third adaptation layer PDU comprises the fourth field, the third field in a header of the third adaptation layer PDU comprises the second old source ID and the fourth field in a header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU;

transmit a fourth MAC PDU group, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

Specifically, according to one aspect of the present disclosure, receive a second message group; the second message group indicates a fourth new ID and a first new destination ID;

upon reception of the second message, transmit a first response message, the first response message comprising the third new ID; after the first response message is transmitted, update the fourth old ID as the fourth new ID.

Specifically, according to one aspect of the present disclosure, transmit a first request message, the first request message comprising the third new ID; the third request message is used to request for a link layer ID update;

receive a second response message, the second response message being used for acceptance of the first request message;

upon reception of the second response message, transmit a second acknowledgement message, the second acknowledgement message being used for acknowledgement of the second response message; soon after the second acknowledgement message is sent out, update the fourth old ID as the fourth new ID.

Specifically, according to one aspect of the present disclosure, receive a fifth MAC PDU group, the fifth MAC PDU group comprising a fifth adaptation layer PDU; the fifth adaptation layer PDU comprises a third PDCP PDU; when a header of the fifth adaptation layer PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID;

transmit a sixth MAC PDU group, the sixth MAC PDU group comprising a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

Specifically, according to one aspect of the present disclosure, receive a seventh MAC PDU group, with either the first field or the second field in a MAC Header of any MAC PDU in the seventh MAC PDU group comprising at least part of bits in a first ID; the seventh MAC PDU group comprises a seventh adaptation layer PDU, and the third field in a header of the seventh adaptation layer PDU comprises a second ID;

when the first ID belongs to a first ID set and a second ID belongs to a second ID set, or, when the first ID belongs to the second ID set and the second ID belongs to the first ID set, drop the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

Specifically, according to one aspect of the present disclosure, the first node is a UE.

Specifically, according to one aspect of the present disclosure, the first node is a terminal of Internet of Things (IoT).

Specifically, according to one aspect of the present disclosure, the first node is a relay.

Specifically, according to one aspect of the present disclosure, the first node is a vehicle-mounted terminal.

Specifically, according to one aspect of the present disclosure, the first node is an aircraft.

The present disclosure provides a method in a second node for wireless communications, comprising:

transmitting a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

a receiver of the first MAC PDU group transmitting a second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

Specifically, according to one aspect of the present disclosure, the third field in a header of the first adaptation layer PDU comprises the first new source ID, and a fourth field in a header of the first adaptation layer PDU comprises a first new destination ID;

when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID.

Specifically, according to one aspect of the present disclosure, transmit a first signaling and a third MAC PDU group; the first signaling indicates the first old source ID and a second old source ID; the first field in a MAC Header of any MAC PDU in the third MAC PDU group comprises at least part of bits in a first old ID; the second field in a MAC Header of any MAC PDU in the third MAC PDU group comprises at least part of bits in a second old ID; the third MAC PDU group comprises a third adaptation layer PDU; when a header of the third adaptation layer PDU comprises the fourth field, the third field in a header of the third adaptation layer PDU comprises the second old source ID and the fourth field in a header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU;

the receiver of the first MAC PDU group, transmitting a fourth MAC PDU group, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

Specifically, according to one aspect of the present disclosure, the receiver of the first MAC PDU group, receiving a fifth MAC PDU group, the fifth MAC PDU group comprising a fifth adaptation layer PDU; the fifth adaptation layer PDU comprises a third PDCP PDU; when a header of the fifth adaptation layer PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID;

receiving a sixth MAC PDU group, the sixth MAC PDU group comprising a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

Specifically, according to one aspect of the present disclosure, transmit a third message group, the third message group indicating a first new source ID.

Specifically, according to one aspect of the present disclosure, receive a seventh MAC PDU group, with either the first field or the second field in a MAC Header of any MAC PDU in the seventh MAC PDU group comprising at least part of bits in a first ID; the seventh MAC PDU group comprises a seventh adaptation layer PDU, and the third field in a header of the seventh adaptation layer PDU comprises a second ID;

when the first ID belongs to a first ID set and a second ID belongs to a second ID set, or, when the first ID belongs to the second ID set and the second ID belongs to the first ID set, drop the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

Specifically, according to one aspect of the present disclosure, the second node is a UE.

Specifically, according to one aspect of the present disclosure, the second node is a terminal of Internet of Things (IoT).

Specifically, according to one aspect of the present disclosure, the second node is a relay.

Specifically, according to one aspect of the present disclosure, the second node is a vehicle-mounted terminal.

Specifically, according to one aspect of the present disclosure, the second node is an aircraft.

The present disclosure provides a method in a third node for wireless communications, comprising:

a transmitter of the second MAC PDU group receiving a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

receiving the second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

Specifically, according to one aspect of the present disclosure, the third field in a header of the first adaptation layer PDU comprises the first new source ID, and a fourth field in a header of the first adaptation layer PDU comprises a first new destination ID;

when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID.

Specifically, according to one aspect of the present disclosure, a transmitter of the second MAC PDU group, receiving a first signaling and a third MAC PDU group; the first signaling indicates the first old source ID and a second old source ID; the first field in a MAC Header of any MAC PDU in the third MAC PDU group comprises at least part of bits in a first old ID; the second field in a MAC Header of any MAC PDU in the third MAC PDU group comprises at least part of bits in a second old ID; the third MAC PDU group comprises a third adaptation layer PDU; when a header of the third adaptation layer PDU comprises the fourth field, the third field in a header of the third adaptation layer PDU comprises the second old source ID and the fourth field in a header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU;

receiving a fourth MAC PDU group, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

Specifically, according to one aspect of the present disclosure, transmit a second message group; the second message group indicates a fourth new ID and a first new destination ID;

receive a first response message, the first response message being used to respond to the second message, the first response message comprising the third new ID; upon transmission of the first response message, the transmitter of the second MAC PDU updating the fourth old ID as the fourth new ID; transmitting a first acknowledgement message, the first acknowledgement message being used to acknowledge the first response message, upon reception of the first acknowledgement message, updating the fourth old ID as the fourth new ID.

Specifically, according to one aspect of the present disclosure, receive a first request message, the first request message comprising the third new ID; the third request message is used to request for a link layer ID update;

transmit a second response message, the second response message being used for acceptance of the first request message;

upon reception of the second response message, receive a second acknowledgement message, the second acknowledgement message being used for acknowledgement of the second response message; soon after the second acknowledgement message is sent out, the transmitter of the second MAC PDU group, updating the fourth old ID as the fourth new ID; after the second acknowledgement message is received, update the fourth old ID as the fourth new ID.

Specifically, according to one aspect of the present disclosure, transmit a fifth MAC PDU group, the fifth MAC PDU group comprising a fifth adaptation layer PDU; the fifth adaptation layer PDU comprises a third PDCP PDU; when a header of the fifth adaptation layer

PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID;

the transmitter of the second MAC PDU group, transmitting a sixth MAC PDU group, the sixth MAC PDU group comprising a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

Specifically, according to one aspect of the present disclosure, receive a seventh MAC PDU group, with either the first field or the second field in a MAC Header of any MAC PDU in the seventh MAC PDU group comprising at least part of bits in a first ID; the seventh MAC PDU group comprises a seventh adaptation layer PDU, and the third field in a header of the seventh adaptation layer PDU comprises a second ID;

when the first ID belongs to a first ID set and a second ID belongs to a second ID set, or, when the first ID belongs to the second ID set and the second ID belongs to the first ID set, drop the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

Specifically, according to one aspect of the present disclosure, receive a third message group, the third message group indicating a first new source ID.

Specifically, according to one aspect of the present disclosure, transmit a first radio signal, the first radio signal comprising the first signaling.

Specifically, according to one aspect of the present disclosure, the third node is a base station.

Specifically, according to one aspect of the present disclosure, the third node is a relay.

Specifically, according to one aspect of the present disclosure, the third node is a vehicle-mounted terminal.

Specifically, according to one aspect of the present disclosure, the third node is an aircraft.

Specifically, according to one aspect of the present disclosure, the third node is a group header.

Specifically, according to one aspect of the present disclosure, the third node is a satellite.

The present disclosure provides a first node for wireless communications, comprising:

a first receiver, which receives a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

a first transmitter, which transmits a second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC

PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

The present disclosure provides a second node for wireless communications, comprising:

a second transmitter, which transmits a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first

MAC PDU group comprises at least part of bits in a second new ID; the first MAC PDU group comprises a first adaptation layer PDU, the first adaptation layer PDU comprising a first PDCP PDU;

a receiver of the first MAC PDU group transmitting a second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

The present disclosure provides a third node for wireless communications, comprising:

a transmitter of the second MAC PDU group, which receives a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

a third receiver, which receives the second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, compared with the prior art, the present disclosure is advantageous in the following aspects:

firstly, the method proposed herein can solve the issue of privacy protection in simultaneous transmissions of IDs in 2-hop link, thus avoiding the asynchronization at a time when a second hop does not update its ID while a first hop already updates its ID, which enables the listener to associated old and new IDs. More importantly, the method guarantees the continuity of data transmissions, namely, regardless of whether and when ID update is performed on the second hop, the data transmission will be continuous. The method herein does not force the IDs of these two hops to be synchronized, which is a benefit to reducing the complexity of system design. If the ID updates are closed coupled, the complexity will increase a lot, unless the coordination is deliberately planned, there may be data interruption, for instance, the second hop may deny or fail an update. At this time, if according to the above comparative method, a link interruption or release will even occur, making the whole system unreliable and unstable. This is very important for multi-hop system, because when there are multiple relay nodes, or a source UE or destination UE is also connected to other UEs, or a source UE is required to communicate with multiple destination UEs through a relay node, the coordination between these UEs will be terribly difficult. The method in the present disclosure proves to be practical and easily comprehensible in ensuring privacy and security without such coordination.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of receiving a first message group and a first MAC PDU group, and transmitting a second MAC PDU group according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication device and a second communication device according to one embodiment of the present disclosure.

FIG. 5 illustrates a flowchart of radio signal transmission according to one embodiment of the present disclosure.

FIG. 6 illustrates a flowchart of radio signal transmission according to one embodiment of the present disclosure.

FIG. 7 illustrates a flowchart of radio signal transmission according to one embodiment of the present disclosure.

FIG. 8 illustrates a schematic diagram of a MAC PDU according to one embodiment of the present disclosure.

FIG. 9 illustrates a schematic diagram of an adaptation layer PDU according to one embodiment of the present disclosure.

FIG. 10 illustrates a schematic diagram of an adaptation layer PDU according to one embodiment of the present disclosure.

FIG. 11 illustrates a schematic diagram of a topological structure according to one embodiment of the present disclosure.

FIG. 12 illustrates a structure block diagram of a processing device in a first node according to one embodiment of the present disclosure.

FIG. 13 illustrates a structure block diagram of a processing device in a second node according to one embodiment of the present disclosure.

FIG. 14 illustrates a structure block diagram a processing device in a third node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

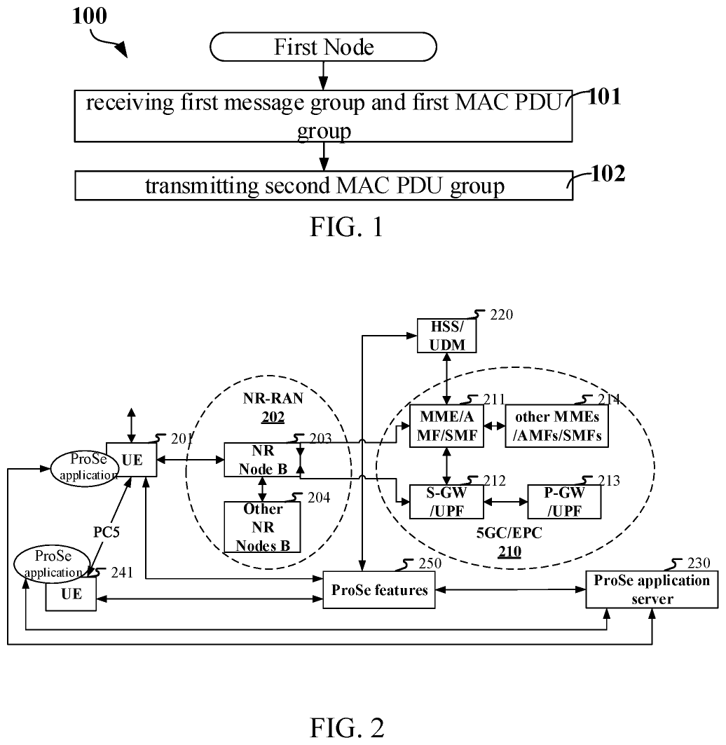

Embodiment 1 illustrates a flowchart of receiving a first message group and a first MAC PDU group, and transmitting a second MAC PDU group, as shown in FIG. 1. In FIG. 1, each box represents a step, it should be particularly noted that the sequence of each box does not imply a chronological order of the steps illustrated in the figure.

In Embodiment 1, the first node in the present disclosure receives a first message group and a first MAC PDU group in step 101; and transmits a second MAC PDU group in step 102;

herein, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU; the second MAC PDU group comprises a second adaptation layer PDU; the second adaptation layer PDU comprises the first PDCP PDU; when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the first node is a remote node.

In one embodiment, the first node is a remote UE.

In one embodiment, the first node is in communication via a sidelink.

In one embodiment, the first node receives the first message group and the first MAC PDU group via a PC5 interface.

In one embodiment, the first node transmits the second MAC PDU group via a PC5 interface.

In one embodiment, the link layer comprises a link layer.

In one embodiment, the link layer comprises a Layer 2.

In one embodiment, the link layer comprises a MAC.

In one embodiment, the link layer ID is a Layer-2 ID.

In one embodiment, the link layer ID is a Layer 2 ID.

In one embodiment, the link layer ID is a L2 ID.

In one embodiment, the link layer ID is a Layer 2 identity.

In one embodiment, the link layer ID is a Layer 2 identifier.

In one embodiment, the link layer ID comprises a Layer-2 ID.

In one embodiment, the link layer ID comprises a Layer 2 ID.

In one embodiment, the link layer ID comprises a L2 ID.

In one embodiment, the link layer ID comprises a Layer 2 identity.

In one embodiment, the link layer ID comprises a Layer 2 identifier.

In one embodiment, the link layer ID is a Link Layer identifier.

In one embodiment, the link layer ID is a Link Layer identity.

In one embodiment, the link layer ID comprises 24 bits.

In one embodiment, the first field in a MAC Header of any MAC PDU in the first MAC PDU group is a SRC field.

In one embodiment, the second field in a MAC Header of any MAC PDU in the first MAC PDU group is a DST field.

In one embodiment, the first field in a MAC Header of any MAC PDU in the second MAC PDU group is a SRC field.

In one embodiment, the second field in a MAC Header of any MAC PDU in the second MAC PDU group is a DST field.

In one embodiment, the first field is a field for indicating a link layer ID of a source.

In one embodiment, the first field is a field for indicating a link layer ID of a destination or a target.

In one embodiment, the first field in a MAC Header of any MAC PDU in the first MAC PDU group comprises N1 bits in the first new ID.

In one subembodiment, the N1 bits in the first new ID are N1 most significant bits (MSB) in the first new ID.

In one subembodiment, the N1 bits in the first new ID are N1 least significant bits (LSB) in the first new ID.

In one subembodiment, N1 is equal to 8.

In one subembodiment, N1 is equal to 16.

In one subembodiment, N1 is equal to 12.

In one embodiment, the second field in a MAC Header of any MAC PDU in the first MAC PDU group comprises N2 bits in the second new ID.

In one subembodiment, the N2 bits in the second new ID are N2 most significant bits (MSB) in the second new ID.

In one subembodiment, the N2 bits in the second new ID are N2 least significant bits (LSB) in the second new ID.

In one subembodiment, N2 is equal to 8.

In one subembodiment, N2 is equal to 16.

In one subembodiment, N2 is equal to 12.

In one embodiment, the first field in a MAC Header of any MAC PDU in the second MAC PDU group comprises N3 bits in the third new ID.

In one subembodiment, the N3 bits in the third new ID are N3 most significant bits (MSB) in the third new ID.

In one subembodiment, the N3 bits in the third new ID are N3 least significant bits (LSB) in the third new ID.

In one subembodiment, N3 is equal to 8.

In one subembodiment, N3 is equal to 16.

In one subembodiment, N3 is equal to 12.

In one embodiment, the second field in a MAC Header of any MAC PDU in the second MAC PDU group comprises N4 bits in the fourth new ID.

In one subembodiment, the N4 bits in the fourth new ID are N4 most significant bits (MSB) in the fourth new ID.

In one subembodiment, the N4 bits in the fourth new ID are N4 least significant bits (LSB) in the fourth new ID.

In one subembodiment, N4 is equal to 8.

In one subembodiment, N4 is equal to 16.

In one subembodiment, N4 is equal to 12.

In one embodiment, the first field in a MAC Header of any MAC PDU in the second MAC PDU group comprises N5 bits in the third old ID.

In one subembodiment, the N5 bits in the third old ID are N5 most significant bits (MSB) in the third old ID.

In one subembodiment, the N5 bits in the third old ID are N5 least significant bits (LSB) in the third old ID.

In one subembodiment, N5 is equal to 8.

In one subembodiment, N5 is equal to 16.

In one subembodiment, N5 is equal to 12.

In one embodiment, the second field in a MAC Header of any MAC PDU in the second MAC PDU group comprises N6 bits in the fourth old ID.

In one subembodiment, the N6 bits in the fourth old ID are N6 most significant bits (MSB) in the fourth old ID.

In one subembodiment, the N6 bits in the fourth old ID are N6 least significant bits (LSB) in the fourth old ID.

In one subembodiment, N6 is equal to 8.

In one subembodiment, N6 is equal to 16.

In one subembodiment, N6 is equal to 12.

In one embodiment, the first MAC PDU group comprises 1 MAC PDU.

In one embodiment, the first MAC PDU group comprises K1 MAC PDU(s), K1 being a positive integer.

In one embodiment, the second MAC PDU group comprises 1 MAC PDU.

In one embodiment, the second MAC PDU group comprises K2 MAC PDU(s), K2 being a positive integer.

In one embodiment, each MAC PDU in the first MAC PDU group is transmitted by a sidelink.

In one embodiment, each MAC PDU in the second MAC PDU group is transmitted by a sidelink.

In one embodiment, a physical channel occupied by each MAC PDU in the first MAC PDU group comprises a PSSCH.

In one embodiment, a physical channel occupied by each MAC PDU in the second MAC PDU group comprises a PSSCH.

In one embodiment, each message comprised in the first message group is a PC5-S message.

In one embodiment, each message comprised in the first message group is a PC5-RRC message.

In one embodiment, the first message group comprises both PC5-RRC message(s) and PC5-S message(s).

In one embodiment, messages in the first message group share a same transmitter.

In one embodiment, messages in the first message group are transmitted by different transmitters.

In one embodiment, transmitters for messages in the first message group are a source UE and a destination UE, respectively.

In one subembodiment, in the first message group, the message sent from the source UE is a PC5-S message, while the message sent from the target UE is a PC5-RRC message.

In one embodiment, the first message group comprises S1 message(s), where Si is a positive integer.

In one embodiment, the first message group comprises DIRECT LINK IDENTIFIER UPDATE REQUEST.

In one embodiment, the first message group comprises DIRECT LINK IDENTIFIER UPDATE ACK.

In one embodiment, the first message group comprises DIRECT LINK IDENTIFIER UPDATE ACCEPT.

In one embodiment, the first message group comprises DIRECT LINK ESTABLISHMENT REQUEST.

In one embodiment, the first message group comprises DIRECT LINK ESTABLISHMENT ACCEPT.

In one embodiment, the first message group comprises DIRECT LINK MODIFICATION REQUEST.

In one embodiment, the first message group comprises DIRECT LINK MODIFICATION ACCEPT.

In one embodiment, the first message group comprises RRCReconfigurationSidelink.

In one embodiment, the first message group comprises RRCConnectionReconfigurationSidelink.

In one embodiment, the first new ID and the first new source ID are carried by different messages in the first message group.

In one embodiment, the first new ID and the first new source ID are carried by a same message in the first message group.

In one embodiment, the first new source ID is generated by the first new ID.

In one subembodiment, the first new source ID is partial bits comprised in the first new ID.

In one subembodiment, the first new source ID is the first new ID.

In one embodiment, the first new source ID is a link layer ID.

In one embodiment, the first new source ID is determined by an application ID.

In one subembodiment, the first new source ID is an application ID.

In one subembodiment, the first new source ID is partial bits comprised in an application ID.

In one subembodiment, the first new source ID is comprised of partial bits comprised in an application ID and partial bits comprised in a link layer ID.

In one embodiment, the first new source ID is an application identifier.

In one embodiment, the first new source ID is an app ID.

In one embodiment, the first new source ID is determined by an application layer ID.

In one embodiment, the first new source ID is an application layer ID.

In one embodiment, the first new source ID is partial bits in an application layer ID.

In one embodiment, the first new source ID is comprised of partial bits in an application layer ID and partial bits in a link layer ID.

In one embodiment, the first new source ID is comprised of partial bits in an application layer ID and partial bits in the first new ID.

In one embodiment, the first new source ID is an identity of a node other than the first node.

In one embodiment, the first new source ID is an identity of a source UE.

In one embodiment, the first new source ID is a Radio Network Temporary Identity (RNTI).

In one subembodiment, the first new source ID is an RNTI of a node other than the first node.

In one subembodiment, the first new source ID is an RNTI of a source node.

In one embodiment, the first new source ID is an identity of a transmitter transmitting the first message group.

In one embodiment, the first new source ID is an identity of a unicast link between a source UE and the first node.

In one embodiment, the first new source ID is a unicast link identifier.

In one embodiment, the first new source ID comprises at least part of bits in an RNTI and at least part of bits in a link layer ID.

In one embodiment, the first new source ID comprises at least part of bits in an RNTI and at least part of bits in the first new ID.

In one embodiment, the first new source ID comprises at least part of bits in an RNTI and at least part of bits in an application ID.

In one embodiment, the first new source ID comprises at least part of bits in an RNTI and at least part of bits in an application layer ID.

In one embodiment, the first new source ID comprises an IP address.

In one embodiment, the first new source ID comprises partial bits in an IP address.

In one embodiment, the first new source ID comprises partial bits in an IP address of a source UE.

In one embodiment, the first adaptation layer PDU is a PDU in an adaptation layer.

In one embodiment, the adaptation layer is an adaptation layer.

In one embodiment, the adaptation layer is a sidelink adaptation layer.

In one embodiment, the adaptation layer is a sl-ap.

In one embodiment, the adaptation layer is an AP layer.

In one embodiment, any MAC PDU in the first MAC PDU group carries the first adaptation layer PDU.

In one embodiment, the first adaptation layer PDU carries the first PDCP PDU.

In one embodiment, the second adaptation layer PDU carries the first PDCP PDU.

In one embodiment, the first adaptation layer PDU and the second adaptation layer PDU carry a same SDU.

In one embodiment, the first old source ID is generated by the first old ID.

In one subembodiment, the first old source ID is partial bits comprised in the first old ID.

In one subembodiment, the first old source ID is the first old ID.

In one embodiment, the first old source ID is a link layer ID.

In one embodiment, the first old source ID is determined by an application ID.

In one subembodiment, the first old source ID is an application ID.

In one subembodiment, the first old source ID is partial bits comprised in an application ID.

In one subembodiment, the first old source ID is comprised of partial bits comprised in an application ID and partial bits comprised in a link layer ID.

In one embodiment, the first old source ID is an application identifier.

In one embodiment, the first old source ID is an app ID.

In one embodiment, the first old source ID is determined by an application layer ID.

In one embodiment, the first old source ID is an application layer ID.

In one embodiment, the first old source ID is partial bits in an application layer ID.

In one embodiment, the first old source ID is comprised of partial bits in an application layer ID and partial bits in a link layer ID.

In one embodiment, the first old source ID is comprised of partial bits in an application layer ID and partial bits in the first old ID.

In one embodiment, the first old source ID is an identity of a node other than the first node.

In one embodiment, the first old source ID is an identity of a source UE.

In one embodiment, the first old source ID is an RNTI.

In one subembodiment, the first old source ID is an RNTI of a node other than the first node.

In one subembodiment, the first old source ID is an RNTI of a source node.

In one embodiment, the first old source ID is an identity of a transmitter transmitting the first message group.

In one embodiment, the first old source ID is an identity of a unicast link between a source UE and the first node.

In one embodiment, the first old source ID is a unicast link identifier.

In one embodiment, the first old source ID comprises at least part of bits in an RNTI and at least part of bits in a link layer ID.

In one embodiment, the first old source ID comprises at least part of bits in an RNTI and at least part of bits in the first old ID.

In one embodiment, the first old source ID comprises at least part of bits in an RNTI and at least part of bits in an application ID.

In one embodiment, the first old source ID comprises at least part of bits in an RNTI and at least part of bits in an application layer ID.

In one embodiment, the first old source ID comprises an IP address.

In one embodiment, the first old source ID comprises partial bits in an IP address.

In one embodiment, the first old source ID comprises partial bits in an IP address of a source UE.

In one embodiment, the third field in the first adaptation layer PDU is used to indicate a source identity.

In one embodiment, the third field in the first adaptation layer PDU is used to indicate a source ID.

In one embodiment, the third field in the first adaptation layer PDU is used to indicate an identity of a source UE.

In one embodiment, the third field in the first adaptation layer PDU is used to indicate an identity of a source node.

In one embodiment, the third field in the first adaptation layer PDU is a SRC field.

In one embodiment, the third field in the first adaptation layer PDU is a SOURCE field.

In one embodiment, the third field in the first adaptation layer PDU is used to indicate an identity of a generator of an SDU carried by the first adaptation layer PDU.

In one embodiment, the third field in the second adaptation layer PDU is used to indicate a source identity.

In one embodiment, the third field in the second adaptation layer PDU is used to indicate a source ID.

In one embodiment, the third field in the second adaptation layer PDU is used to indicate an identity of a source UE.

In one embodiment, the third field in the second adaptation layer PDU is used to indicate an identity of a source node.

In one embodiment, the third field in the second adaptation layer PDU is a SRC field.

In one embodiment, the third field in the second adaptation layer PDU is a SOURCE field.

In one embodiment, the third field in the second adaptation layer PDU is used to indicate an identity of a generator of an SDU carried by the first adaptation layer PDU.

In one embodiment, the first new source ID and the first old source ID are used to determine, identify, or indicate a same application.

In one embodiment, the first new source ID and the first old source ID are used to determine, identify, or indicate a same UE.

In one embodiment, the first new source ID and the first old source ID are used to determine, identify, or indicate a same node.

In one embodiment, the first new source ID and the first old source ID are used to determine, identify, or indicate a same link.

In one embodiment, the first new source ID and the first old source ID are used to determine, identify, or indicate a same entity.

In one embodiment, the first new source ID and the first new ID are used to determine, identify, or indicate a same application.

In one embodiment, the first new source ID and the first new ID are used to determine, identify, or indicate a same UE.

In one embodiment, the first new source ID and the first new ID are used to determine, identify, or indicate a same node.

In one embodiment, the first new source ID and the first new ID are used to determine, identify, or indicate a same link.

In one embodiment, the first new source ID and the first new ID are used to determine, identify, or indicate a same entity.

In one embodiment, the first new ID is one of source Layer-2 ID(s) maintained by the first node.

In one embodiment, the second new ID is one of destination Layer-2 ID(s) maintained by the first node.

In one embodiment, the third new ID is one of source Layer-2 ID(s) maintained by the first node.

In one embodiment, the fourth new ID is one of destination Layer-2 ID(s) maintained by the first node.

In one embodiment, the first old ID is one of source Layer-2 ID(s) maintained by the first node.

In one embodiment, the second old ID is one of destination Layer-2 ID(s) maintained by the first node.

In one embodiment, the third old ID is one of source Layer-2 ID(s) maintained by the first node.

In one embodiment, the fourth old ID is one of destination Layer-2 ID(s) maintained by the first node.

In one embodiment, reception of the second message group triggers the fourth old ID being updated as the fourth new ID.

In one embodiment, upon reception of a message of request for link update of a UE having the fourth old ID the first node is triggered to update the fourth old ID as the fourth new ID.

In one embodiment, after the fourth old ID is updated as the fourth new ID, the first node stops transmitting any MAC PDU with a MAC header comprising the fourth old ID.

In one embodiment, at a time when the fourth old ID is updated as the fourth new ID, the third old ID is updated as the third new ID.

In one embodiment, at a time when the third old ID is updated as the third new ID, the fourth old ID is updated as the fourth new ID.

In one embodiment, after the third old ID is updated as the third new ID, the first node stops transmitting any MAC PDU with a MAC header comprising the third old ID.

In one embodiment, upon a fourth old ID's being updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID.

In one embodiment, before the fourth old ID is updated as a fourth new ID, the first field in a MAC Header of a MAC PDU transmitted by the first node does not comprise the third new ID; and the second field herein does not comprise the fourth new ID.

In one embodiment, the phrase that the fourth old ID is updated as a fourth new ID includes a meaning that the second field in a MAC Header of a MAC PDU transmitted by the first node does not comprise the fourth old ID.

In one embodiment, the phrase that the fourth old ID is updated as a fourth new ID includes a meaning that the second field in a MAC Header of a MAC PDU transmitted by the first node to a UE having the fourth old ID comprises the fourth new ID rather than the fourth old ID.

In one subembodiment, the first field in a MAC Header of the MAC PDU in the above embodiment comprises the third new ID rather than the third old ID.

In one embodiment, the phrase that the fourth old ID is updated as a fourth new ID includes a meaning that the second field in a MAC Header of a MAC PDU transmitted by the first node to a UE having the fourth new ID comprises the fourth new ID rather than the fourth old ID.

In one subembodiment, the first field in a MAC Header of the MAC PDU in the above embodiment comprises the third new ID rather than the third old ID.

In one embodiment, the phrase that the fourth old ID is updated as a fourth new ID includes a meaning that the fourth old ID and the fourth new ID are identities of a same UE or a same target or destination UE.

In one embodiment, the phrase that the fourth old ID is updated as a fourth new ID includes a meaning that the fourth old ID and the fourth new ID are identities in a same unicast link profile.

In one embodiment, the phrase that the fourth old ID is updated as a fourth new ID includes a meaning that before the fourth old ID is updated as the fourth new ID, a first unicast link profile of a first unicast link comprises the fourth old ID and the third old ID; after the fourth old ID is updated as the fourth new ID, a first unicast link profile of a first unicast link comprises the fourth new ID and the third new ID rather than the fourth old ID and the third old ID.

In one embodiment, the phrase that the fourth old ID is updated as a fourth new ID includes a meaning that the first node stops transmitting a MAC PDU with a MAC Header in which the second field comprises the fourth old ID.

In one embodiment, the phrase that the fourth old ID is updated as a fourth new ID includes a meaning that the first node stops transmitting a MAC PDU with a MAC Header in which the first field comprises the third old ID.

In one embodiment, upon a fourth old ID's being updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, a third field in a header of the second adaptation layer PDU comprising the first new source ID rather than the first old source ID.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, one or more UEs 241, an NG-RAN 202, a 5G-Core Network/Evolved Packet Core (5GC/EPC) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present disclosure can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client, a vehicle terminal, V2X equipment or some other appropriate terms. The gNB 203 is connected to the 5GC/EPC 210 via an S1/NG interface. The 5GC/EPC 210 comprises a Mobility Management Entity (MME)/ Authentication Management Field (AMF)/ Session Management Function (SMF) 211, other MMEs/AMFs/SMFs 214, a Service Gateway (S-GW)/User Plane Function (UPF) 212 and a Packet Date Network Gateway (P-GW) /UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present disclosure.

In one embodiment, the UE 201 corresponds to the second node in the present disclosure.

In one embodiment, the UE 201 corresponds to the third node in the present disclosure.

In one embodiment, the UE 201 supports transmissions in NTN.

In one embodiment, the UE 201 supports transmissions in a network with large delay difference.

In one embodiment, the UE 201 supports V2X transmissions.

In one embodiment, the UE 201 supports relay transmissions.

In one embodiment, the UE 201 supports ProSe transmissions.

In one embodiment, the UE 241 corresponds to the first node in the present disclosure.

In one embodiment, the UE 241 corresponds to the second node in the present disclosure.

In one embodiment, the UE 241 corresponds to the third node in the present disclosure.

In one embodiment, the UE 241 supports transmissions in NTN.

In one embodiment, the UE 241 supports transmissions in a network with large delay difference.

In one embodiment, the UE 241 supports V2X transmissions.

In one embodiment, the UE 241 supports relay transmissions.

In one embodiment, the UE 241 supports ProSe transmissions.

In one embodiment, between the UE 201 and the UE 241 sidelink transmissions are performed.

### Embodiment 3

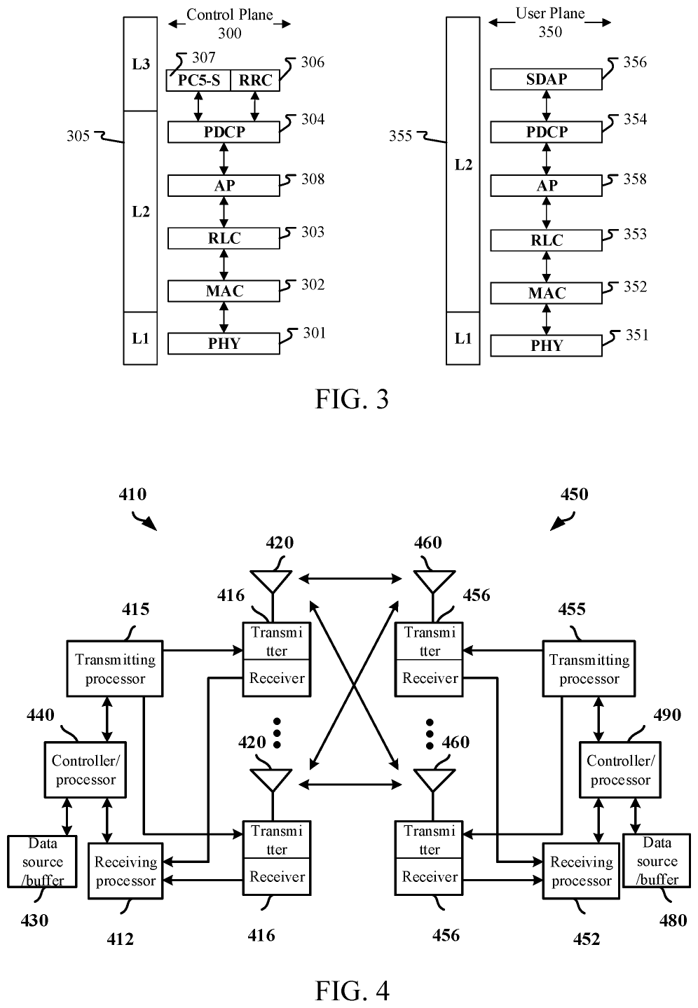

Embodiment 3 illustrates a schematic diagram of a radio protocol architecture of a user plane and a control plane, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present disclosure. The layer 2 (L2) 305 is above the PHY 301, and is in charge of the link between the first node and the second node via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes of the network side. The PDCP sublayer 304 provides multiplexing among variable radio bearers and logical channels. The PDCP sublayer 304 provides security by encrypting a packet and provides support for handover of a first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. A PC5 Signaling Protocol (PC5-S) sublayer 307 is in charge of the processing of signaling protocols of the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355, such as a network layer (i.e., IP layer) terminated at a P-GW 213 of the network side and an application layer terminated at the other side of the connection (i.e., a peer UE, a server, etc.). For a UE involved in relay service, the control plane also comprises an adaptation sublayer AP308, and the user plane also comprises an adaptation sublayer AP358, the introduction of adaptation layer is beneficial to lower layers, like MAC layer and RLC layer, in multiplexing of data from multiple source UEs.

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the radio protocol architecture in FIG. 3 is applicable to the third node in the present disclosure.

In one embodiment, the first message group in the present disclosure is generated by the RRC306 or a PC5-S307.

In one embodiment, the second message group in the present disclosure is generated by the RRC306 or a PC5-S307.

In one embodiment, the first signaling in the present disclosure is generated by the RRC306 or a PC5-S307.

In one embodiment, the first request message in the present disclosure is generated by the RRC306 or a PC5-S307.

In one embodiment, the first response message in the present disclosure is generated by the RRC306 or a PC5-S307.

In one embodiment, the first acknowledgement message in the present disclosure is generated by the RRC306 or a PC5-S307.

In one embodiment, the second response message in the present disclosure is generated by the RRC306 or a PC5-S307.

In one embodiment, the second acknowledgement message in the present disclosure is generated by the RRC306 or a PC5-S307.

In one embodiment, the first MAC PDU group in the present disclosure is generated by the MAC302 or a MAC352.

In one embodiment, the second MAC PDU group in the present disclosure is generated by the MAC302 or a MAC352.

In one embodiment, the third MAC PDU group in the present disclosure is generated by the MAC302 or a MAC352.

In one embodiment, the fourth MAC PDU group in the present disclosure is generated by the MAC302 or a MAC352.

In one embodiment, the fifth MAC PDU group in the present disclosure is generated by the MAC302 or a MAC352.

In one embodiment, the sixth MAC PDU group in the present disclosure is generated by the MAC302 or a MAC352.

In one embodiment, the seventh MAC PDU group in the present disclosure is generated by the MAC302 or a MAC352.

In one embodiment, the first adaptation layer PDU in the present disclosure is generated by the AP308 or a MAC358.

In one embodiment, the second adaptation layer PDU in the present disclosure is generated by the AP308 or a MAC358.

In one embodiment, the third adaptation layer PDU in the present disclosure is generated by the AP308 or a MAC358.

In one embodiment, the fourth adaptation layer PDU in the present disclosure is generated by the AP308 or a MAC358.

In one embodiment, the fifth adaptation layer PDU in the present disclosure is generated by the AP308 or a MAC358.

In one embodiment, the sixth adaptation layer PDU in the present disclosure is generated by the AP308 or a MAC358.

In one embodiment, the seventh adaptation layer PDU in the present disclosure is generated by the AP308 or a MAC358.

In one embodiment, the first PDCP PDU in the present disclosure is generated by the PDCP304 or a PDCP354.

In one embodiment, the second PDCP PDU in the present disclosure is generated by the PDCP304 or a PDCP354.

In one embodiment, the second PDCP PDU in the present disclosure is generated by the PDCP304 or a PDCP354.

### Embodiment 4

Embodiment 4 illustrates a schematic diagram of a first communication device and a second communication device according to the present disclosure, as shown in FIG. 4. FIG. 4 is a block diagram of a first communication device 450 and a second communication device 410 in communication with each other in an access network.

The first communication device 450 comprises a controller/processor 490, a memory or a data source 480, a transmitting processor 455, a receiving processor 452, optionally a multi-antenna transmitting processor and a multi-antenna receiving processor, a transmitter/receiver 456 and an antenna 460.

The second communication device 410 comprises a controller/processor 440, a memory 430, a receiving processor 412, a transmitting processor 415, optionally a multi-antenna receiving processor and a multi-antenna transmitting processor, a transmitter/receiver 416 and an antenna 420.

In a transmission from the second communication device 410 to the first communication device 450, at the second communication device 410, a higher layer packet from a core network is provided to the controller/processor 440. The controller/processor 440 implements the functionality of the L2 layer. In the transmission from the second communication device 410 to the first communication device 450, the controller/processor 440 provides header compression, encryption, packet segmentation and reordering, multiplexing between a logical channel and a transport channel and radio resource allocation based on various priorities. The controller/processor 440 is also in charge of a retransmission of a lost packet and a signaling to the first communication device 450. The transmitting processor 415 and the multi-antenna transmitting processor perform various signal processing functions used for the L1 layer (i.e., PHY). The transmitting processor 415 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor performs digital spatial precoding, including codebook-based precoding and non-codebook-based precoding, and beamforming processing on encoded and modulated symbols to generate one or more spatial streams. The transmitting processor 415 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor performs transmission analog precoding/beamforming on the time-domain multicarrier symbol streams. Each transmitter 416 converts a baseband multicarrier symbol stream provided by the multi-antenna transmitting processor into a radio frequency (RF) stream, which is later provided to antennas 420.

In a transmission from the second communication device 410 to the first communication device 450, at the first communication device 450, each receiver 456 receives a signal via a corresponding antenna 460. Each receiver 456 recovers information modulated onto the RF carrier, and converts the radio frequency stream into a baseband multicarrier symbol stream to be provided to the receiving processor 452. The receiving processor 452 and the multi-antenna receiving processor perform signal processing functions of the L1 layer. The multi-antenna receiving processor performs reception analog precoding/beamforming on a baseband multicarrier symbol stream provided by the receiver 456. The receiving processor 452 converts the processed baseband multicarrier symbol stream from time domain into frequency domain using FFT. In frequency domain, a physical layer data signal and a reference signal are de-multiplexed by the receiving processor 452, wherein the reference signal is used for channel estimation, while the data signal is subjected to multi-antenna detection in the multi-antenna receiving processor to recover any first communication device 450-targeted spatial stream. Symbols on each spatial stream are demodulated and recovered in the receiving processor 452 to generate a soft decision. Then the receiving processor 452 decodes and de-interleaves the soft decision to recover the higher-layer data and control signal transmitted by the second communication device 410. Next, the higher-layer data and control signal are provided to the controller/processor 490. The controller/processor 490 performs functions of the L2 layer. The controller/processor 490 can be associated with a memory 480 that stores program code and data. The memory 480 can be called a computer readable medium. In the transmission from the second communication device 410 to the first communication device 450, the controller/processor 490 provides demultiplexing between a transport channel and a logical channel, packet reassembling, decrypting, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the first communication device 450, the data source is configured to provide a higher-layer packet to the controller/processor 490. The data source represents all protocol layers above the L2 layer. Similar to a transmitting function of the second communication device 410 described in the transmission from the second communication device 410 to the first communication device 450, the controller/processor 490 performs header compression, encryption, packet segmentation and reordering, and multiplexing between a logical channel and a transport channel based on radio resource allocation so as to provide the L2 layer functions used for the user plane and the control plane. The controller/processor 490 is also responsible for a retransmission of a lost packet, and a signaling to the second communication device 410. The transmitting processor 455 performs modulation and mapping, as well as channel coding, and the multi-antenna transmitting processor performs digital multi-antenna spatial precoding, including codebook-based precoding and non-codebook-based precoding, and beamforming. The transmitting processor 455 then modulates generated spatial streams into multicarrier/single-carrier symbol streams. The modulated symbol streams, after being subjected to analog precoding/beamforming in the multi-antenna transmitting processor, are provided from the transmitter 456 to each antenna 460. Each transmitter 456 first converts a baseband symbol stream provided by the multi-antenna transmitting processor into a radio frequency symbol stream, and then provides the radio frequency symbol stream to the antenna 460.

In a transmission from the first communication device 450 to the second communication device 410, the function of the second communication device 410 is similar to the receiving function of the first communication device 450 described in the transmission from the second communication device 410 to the first communication device 450. Each receiver 416 receives a radio frequency signal via a corresponding antenna 420, converts the received radio frequency signal into a baseband signal, and provides the baseband signal to the multi-antenna receiving processor and the receiving processor 412. The receiving processor 412 and the multi-antenna receiving processor jointly provide functions of the L1 layer. The controller/processor 440 provides functions of the L2 layer. The controller/processor 440 can be associated with the memory 430 that stores program code and data. The memory 430 can be called a computer readable medium. In the transmission from the first communication device 450 to the second communication device 410, the controller/processor 440 provides de-multiplexing between a transport channel and a logical channel, packet reassembling, decrypting, header decompression, control signal processing so as to recover a higher-layer packet from the first communication device (UE) 450. The higher-layer packet coming from the controller/processor 440 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first message group and a first MAC PDU group, the first message group indicating a first new source identity (ID) and a first new ID; a first field in a MAC Header of any MAC PDU in the first MAC PDU group comprising at least part of bits in the first new ID; a second field in a MAC Header of any MAC PDU in the first MAC PDU group comprising at least part of bits in a second new ID; the first MAC PDU group comprising a first adaptation layer PDU, the first adaptation layer PDU comprising a first PDCP PDU; and transmits a second MAC PDU group; the second MAC PDU group comprising a second adaptation layer PDU; the second adaptation layer PDU comprising the first PDCP PDU; herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the first communication device 450 comprises a memory that stores a computer readable instruction program. The computer readable instruction program generates actions when executed by at least one processor. The actions include: receiving a first message group and a first MAC PDU group, the first message group indicating a first new source identity (ID) and a first new ID; a first field in a MAC Header of any MAC PDU in the first MAC PDU group comprising at least part of bits in the first new ID; a second field in a MAC Header of any MAC PDU in the first MAC PDU group comprising at least part of bits in a second new ID; the first MAC PDU group comprising a first adaptation layer PDU, the first adaptation layer PDU comprising a first PDCP PDU; and transmitting a second MAC PDU group; the second MAC PDU group comprising a second adaptation layer PDU; the second adaptation layer PDU comprising the first PDCP PDU; herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the second communication device 410 comprises at least one processor and at least one memory. The at least one memory comprises computer program codes. The at least one memory and the computer program codes are configured to be used in collaboration with the at least one processor. The second communication device 410 at least transmits a first message group and a first MAC PDU group, the first message group indicating a first new source identity (ID) and a first new ID; a first field in a MAC Header of any MAC PDU in the first MAC PDU group comprising at least part of bits in the first new ID; a second field in a MAC Header of any MAC PDU in the first MAC PDU group comprising at least part of bits in a second new ID; the first MAC PDU group comprising a first adaptation layer PDU, the first adaptation layer PDU comprising a first PDCP PDU; a receiver of the first MAC PDU group transmits a second MAC PDU group; the second MAC PDU group comprising a second adaptation layer PDU; the second adaptation layer PDU comprising the first PDCP PDU; herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the second communication device 410 comprises a memory that stores a computer readable instruction program. The computer readable instruction program generates actions when executed by at least one processor. The actions include: transmitting a first message group and a first MAC PDU group, the first message group indicating a first new source identity (ID) and a first new ID; a first field in a MAC Header of any MAC PDU in the first MAC PDU group comprising at least part of bits in the first new ID; a second field in a MAC Header of any MAC PDU in the first MAC PDU group comprising at least part of bits in a second new ID; the first MAC PDU group comprising a first adaptation layer PDU, the first adaptation layer PDU comprising a first PDCP PDU; a receiver of the first MAC PDU group transmitting a second MAC PDU group; the second MAC PDU group comprising a second adaptation layer PDU; the second adaptation layer PDU comprising the first PDCP PDU; herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the second communication device 410 comprises at least one processor and at least one memory. The at least one memory comprises computer program codes. The at least one memory and the computer program codes are configured to be used in collaboration with the at least one processor. The second communication device 410 at least: a transmitter of the second MAC PDU group, receiving a first message group and a first MAC

PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU; receives the second MAC PDU group; the second MAC PDU group comprises a second adaptation layer PDU; the second adaptation layer PDU comprises the first PDCP PDU; herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the second communication device 410 comprises a memory that stores a computer readable instruction program. The computer readable instruction program generates actions when executed by at least one processor. The actions include: a transmitter of the second MAC PDU group receiving a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU; receiving the second MAC PDU group; the second MAC PDU group comprises a second adaptation layer PDU; the second adaptation layer PDU comprises the first PDCP PDU; herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the first communication device 450 corresponds to the first node in the present disclosure.

In one embodiment, the second communication device 410 corresponds to the second node in the present disclosure.

In one embodiment, the second communication device 410 corresponds to the third node in the present disclosure.

In one embodiment, the first communication device 450 is a UE.

In one embodiment, the first communication device 450 is a vehicle-mounted terminal.

In one embodiment, the first communication device 450 is a relay.

In one embodiment, the first communication device 450 is a satellite.

In one embodiment, the second communication device 410 is a base station.

In one embodiment, the second communication device 410 is a relay.

In one embodiment, the second communication device 410 is a UE.

In one embodiment, the second communication device 410 is a satellite.

In one embodiment, the receiver 456 (comprising the antenna 460), the receiving processor 452 and the controller/processor 490 are used for receiving the first message group in the present disclosure.

In one embodiment, the receiver 456 (comprising the antenna 460), the receiving processor 452 and the controller/processor 490 are used for receiving the second message group in the present disclosure.

In one embodiment, the receiver 456 (comprising the antenna 460), the receiving processor 452 and the controller/processor 490 are used for receiving the first signaling in the present disclosure.

In one embodiment, the receiver 456 (comprising the antenna 460), the receiving processor 452 and the controller/processor 490 are used for receiving the first acknowledgement message in the present disclosure.

In one embodiment, the receiver 456 (comprising the antenna 460), the receiving processor 452 and the controller/processor 490 are used for receiving the second response message in the present disclosure.

In one embodiment, the receiver 456 (comprising the antenna 460), the receiving processor 452 and the controller/processor 490 are used for receiving the first MAC PDU group in the present disclosure.

In one embodiment, the receiver 456 (comprising the antenna 460), the receiving processor 452 and the controller/processor 490 are used for receiving the third MAC PDU group in the present disclosure.

In one embodiment, the receiver 456 (comprising the antenna 460), the receiving processor 452 and the controller/processor 490 are used for receiving the fifth MAC PDU group in the present disclosure.

In one embodiment, the receiver 456 (comprising the antenna 460), the receiving processor 452 and the controller/processor 490 are used for receiving the seventh MAC PDU group in the present disclosure.

In one embodiment, the transmitter 456 (comprising the antenna 460), the transmitting processor 455 and the controller/processor 490 are used for transmitting the first request message in the present disclosure.

In one embodiment, the transmitter 456 (comprising the antenna 460), the transmitting processor 455 and the controller/processor 490 are used for transmitting the first response message in the present disclosure.

In one embodiment, the transmitter 456 (comprising the antenna 460), the transmitting processor 455 and the controller/processor 490 are used for transmitting the second acknowledgement message in the present disclosure.

In one embodiment, the transmitter 456 (comprising the antenna 460), the transmitting processor 455 and the controller/processor 490 are used for transmitting the second MAC PDU group in the present disclosure.

In one embodiment, the transmitter 456 (comprising the antenna 460), the transmitting processor 455 and the controller/processor 490 are used for transmitting the fourth MAC PDU group in the present disclosure.

In one embodiment, the transmitter 456 (comprising the antenna 460), the transmitting processor 455 and the controller/processor 490 are used for transmitting the sixth MAC PDU group in the present disclosure.

In one embodiment, the transmitter 416 (comprising the antenna 420), the transmitting processor 412 and the controller/processor 440 are used for transmitting the first message group in the present disclosure.

In one embodiment, the transmitter 416 (comprising the antenna 420), the transmitting processor 412 and the controller/processor 440 are used for transmitting the second message group in the present disclosure.

In one embodiment, the transmitter 416 (comprising the antenna 420), the transmitting processor 412 and the controller/processor 440 are used for transmitting the first signaling in the present disclosure.

In one embodiment, the transmitter 416 (comprising the antenna 420), the transmitting processor 412 and the controller/processor 440 are used for transmitting the first acknowledgement message in the present disclosure.

In one embodiment, the transmitter 416 (comprising the antenna 420), the transmitting processor 412 and the controller/processor 440 are used for transmitting the second response message in the present disclosure.

In one embodiment, the transmitter 416 (comprising the antenna 420), the transmitting processor 412 and the controller/processor 440 are used for transmitting the first MAC PDU group in the present disclosure.

In one embodiment, the transmitter 416 (comprising the antenna 420), the transmitting processor 412 and the controller/processor 440 are used for transmitting the third MAC PDU group in the present disclosure.

In one embodiment, the transmitter 416 (comprising the antenna 420), the transmitting processor 412 and the controller/processor 440 are used for transmitting the fifth MAC PDU group in the present disclosure.

In one embodiment, the transmitter 416 (comprising the antenna 420), the transmitting processor 412 and the controller/processor 440 are used for transmitting the seventh MAC PDU group in the present disclosure.

In one embodiment, the receiver 416 (comprising the antenna 420), the receiving processor 412 and the controller/processor 440 are used for receiving the first request message in the present disclosure.

In one embodiment, the receiver 416 (comprising the antenna 420), the receiving processor 412 and the controller/processor 440 are used for receiving the first response message in the present disclosure.

In one embodiment, the receiver 416 (comprising the antenna 420), the receiving processor 412 and the controller/processor 440 are used for receiving the second acknowledgement message in the present disclosure.

In one embodiment, the receiver 416 (comprising the antenna 420), the receiving processor 412 and the controller/processor 440 are used for receiving the second MAC PDU group in the present disclosure.

In one embodiment, the receiver 416 (comprising the antenna 420), the receiving processor 412 and the controller/processor 440 are used for receiving the fourth MAC PDU group in the present disclosure.

In one embodiment, the receiver 416 (comprising the antenna 420), the receiving processor 412 and the controller/processor 440 are used for receiving the sixth MAC PDU group in the present disclosure.

### Embodiment 5

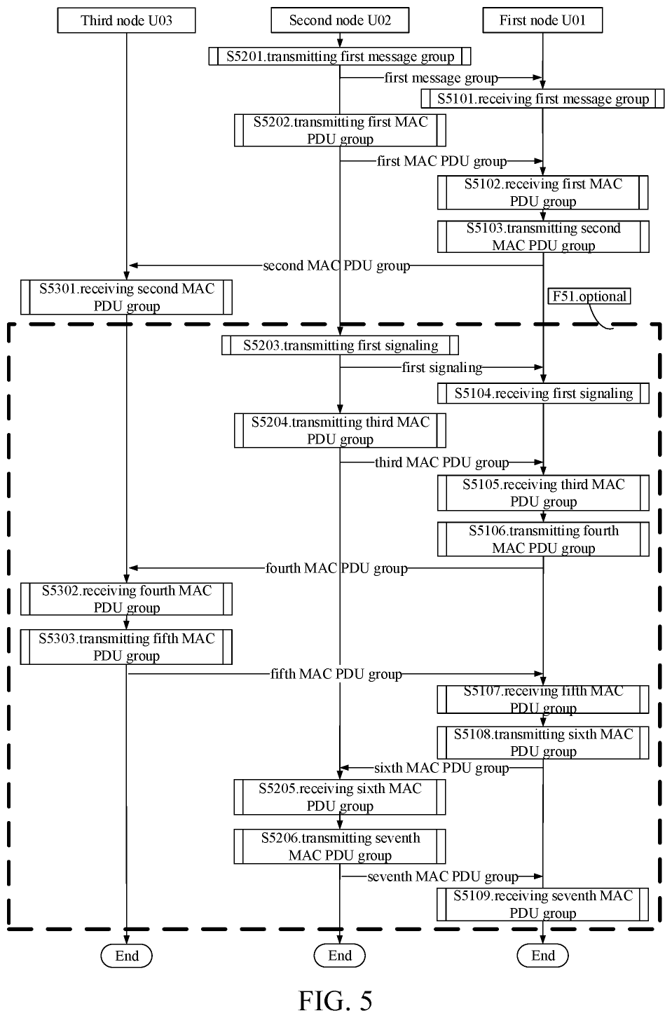

Embodiment 5 illustrates a flowchart of radio signal transmission according to one embodiment of the present disclosure, as shown in FIG. 5. In FIG. 5, U01 corresponds to the first node in the present disclosure, U02 corresponds to the second node in the present disclosure, and U03 corresponds to the third node in the present disclosure; it should be particularly noted that the sequence illustrated in this figure does not set any limit on the order of signal transmissions and implementations in the present disclosure; herein, the steps in the box F51 are optional.

The first node U01 receives a first message group in step S5101; and receives a first MAC PDU group in step S5102; transmits a second MAC PDU group in step S5103; receives a first signaling in step S5104; and receives a third MAC PDU group in step S5105; transmits a fourth MAC PDU group in step S5106; receives a fifth MAC PDU group in step S5107; transmits a sixth MAC PDU group in step S5108; and receives a seventh MAC PDU group in step S5109.

The second node U02 transmits a first message group in step S5201; and transmits a first MAC PDU group in step S5202; transmits a first signaling in step S5203; and transmits a third MAC PDU group in step S5204; receives a sixth MAC PDU group in step S5205; and transmits a seventh MAC PDU group in step S5206.

The third node U03 receives a second MAC PDU group in step S5301; receives a fourth MAC PDU group in step S5302; and transmits a fifth MAC PDU group in step S5303.

In Embodiment 5, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU; the second MAC PDU group comprises a second adaptation layer PDU; the second adaptation layer PDU comprises the first PDCP PDU; when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the first node U01 is a UE.

In one embodiment, the first node U01 is a relay.

In one subembodiment, the first node U01 is a UE with the relay function.

In one subembodiment, the first node U01 is a L2 relay.

In one embodiment, the second node U02 is a remote UE, as illustrated in Embodiment 5, the U02 is a source UE.

In one embodiment, the third node U03 is a remote UE, as illustrated in Embodiment 5, the U03 is a target/destination UE.

In one embodiment, the second node U02 is in communication with the third node U03 via the first node U01.

In one embodiment, PC5 connection is established between the first node U01 and the second node U02.

In one embodiment, PC5 connection is established between the first node U01 and the third node U03.

In one embodiment, PC5 connection is established between the second node U02 and the third node U03.

In one embodiment, the first node U01 and the second node U02 are in communication through a unicast link.

In one embodiment, the first node U01 and the third node U03 are in communication through a unicast link.

In one embodiment, there is a Radio Bearer (RB) between the second node UO2 and the third node U03.

In one embodiment, there is an RLC Bearer between the first node U01 and the third node U03.

In one embodiment, there is an RLC Bearer between the first node U01 and the second node U02.

In one embodiment, the first message group is transmitted through a PC5 interface between the first node U01 and the second node U02.

In one embodiment, the first MAC PDU group is used to generate the second MAC PDU group.

In one embodiment, a message comprised in the first message group is a signaling on the control plane.

In one embodiment, the first new source ID and the second new ID are indicated in a same message.

In one embodiment, the first node U01 periodically triggers updates of the first new source ID and/or the second new ID.

In one embodiment, the second node U02 periodically triggers updates of the first new source ID and/or the second new ID.

In one embodiment, reception of the first message group is prior to reception of the first MAC PDU group, till the reception of the first message group, the first node U01 has not yet updated the fourth old ID as the fourth new ID.

In one embodiment, reception of the first message group is prior to reception of the first MAC PDU group, upon the reception of the first message group, the first node U01 has already updated the fourth old ID as the fourth new ID.

In one embodiment, reception of the second message group is prior to reception of the first MAC PDU group, after the second message group is received, the first node U01 updates the fourth old ID as the fourth new ID; and updates the third old ID as the third new ID.

In one embodiment, reception of the second message group is after reception of the first MAC PDU group, after the second message group is received, the first node U01 updates the fourth old ID as the fourth new ID; and updates the third old ID as the third new ID.

In one embodiment, reception of the first message group is used to trigger a request for the second message group.

In one embodiment, reception of the first message group is used to trigger a request for the second message group.

In one embodiment, reception of the second message group is used to trigger a request for the first message group.

In one embodiment, reception of the second message group is used to trigger a request for the first message group.

In one embodiment, the first old ID does not coexist with the second new ID in a header of a MAC PDU.

In one embodiment, the first new ID does not coexist with the second old ID in a header of a MAC PDU.

In one embodiment, the third old ID does not coexist with the fourth new ID in a header of a MAC PDU.

In one embodiment, the third new ID does not coexist with the fourth old ID in a header of a MAC PDU.

In one embodiment, when the first old ID is updated as the first new ID, the second old ID is updated as the second new ID at the same time.

In one embodiment, when the third old ID is updated as the third new ID, the fourth old ID is updated as the fourth new ID at the same time.

In one embodiment, if a header of an adaptation layer PDU comprises the fourth field, the first new source ID and the first old destination ID do not occur simultaneously in the header of the adaptation layer PDU.

In one embodiment, if a header of an adaptation layer PDU comprises the fourth field, the first old source ID and the first new destination ID do not occur simultaneously in the header of the adaptation layer PDU.

In one embodiment, whether a header of the second adaptation layer PDU comprised in the second MAC PDU group comprises the first new source ID or the first old source ID is unrelated to whether a header of the first adaptation layer PDU comprises the first new source ID or the first old source ID.

In one embodiment, whether a header of the second adaptation layer PDU comprised in the second MAC PDU group comprises the first new source ID or the first old source ID is unrelated to whether a header of a MAC PDU in the first MAC PDU group comprises the first new ID or the first old source ID.

In one embodiment, whether a header of the second adaptation layer PDU comprised in the second MAC PDU group comprises the first new source ID or the first old source ID is related to whether a header of a MAC PDU in the second MAC PDU group comprises the fourth new ID or the fourth old source ID.

In one embodiment, the first signaling indicates the first old source ID and a second old source ID.

In one embodiment, the first signaling indicates the first old source ID and the first new source ID.

In one embodiment, the second old source ID is used before the usage of the first old source ID by a header of an adaptation layer PDU.

In one embodiment, when the second old source ID is used, the first old source ID is not yet used.

In one embodiment, when the first old source ID starts to be used, the usage of the second old source ID is stopped.

In one embodiment, the action of stopping the usage of any one of the first new source ID, the first old source ID, the first new destination ID and the first old destination ID comprises: a header of an adaptation layer PDU no longer comprises any of the first new source ID, the first old source ID, the first new destination ID and the first old destination ID.

In one embodiment, the action of using any one of the first new source ID, the first old source ID, the first new destination ID and the first old destination ID comprises: a header of an adaptation layer PDU comprises any of the first new source ID, the first old source ID, the first new destination ID and the first old destination ID.

In one embodiment, the first signaling comprises a PC5-S signaling.

In one embodiment, the first signaling comprises a PC5-RRC signaling.

In one embodiment, the first signaling is used for updating a link layer ID.

In one embodiment, the first field in a MAC Header of any MAC PDU in the third MAC PDU group comprises at least part of bits in the first old ID; the second field in a MAC Header of any MAC PDU in the third MAC PDU group comprises at least part of bits in the second old ID; the third MAC PDU group comprises a third adaptation layer PDU; when the header of the third adaptation layer PDU comprises the fourth field, the third field in the header of the third adaptation layer PDU comprises the second old source ID and the fourth field in the header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU.

In one embodiment, reception of the third MAC PDU group is prior to reception of the first message group.

In one embodiment, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

In one embodiment, if a header of the fourth adaptation layer PDU comprises the fourth field, the fourth field in the header of the fourth adaptation layer PDU comprises the fourth old destination ID.

In one embodiment, the first field in a MAC Header of any MAC PDU in the third MAC PDU group comprises 16 most significant bits (MSBs) in the first old ID.

In one embodiment, the first field in a MAC Header of any MAC PDU in the third MAC PDU group comprises 16 least significant bits (LSBs) in the first old ID.

In one embodiment, the second field in a MAC Header of any MAC PDU in the third

MAC PDU group comprises 8 MSBs in the second old ID.

In one embodiment, the second field in a MAC Header of any MAC PDU in the third MAC PDU group comprises 8 LSBs in the second old ID.

In one embodiment, the first field in a MAC Header of any MAC PDU in the fourth MAC PDU group comprises 16 MSBs in the third old ID.

In one embodiment, the first field in a MAC Header of any MAC PDU in the fourth MAC PDU group comprises 16 LSBs in the third old ID.

In one embodiment, the second field in a MAC Header of any MAC PDU in the fourth MAC PDU group comprises 8 MSBs in the fourth old ID.

In one embodiment, the second field in a MAC Header of any MAC PDU in the fourth MAC PDU group comprises 8 LSBs in the fourth old ID.

In one embodiment, for a header of an adaptation layer PDU sent by the first node U01, the first old source ID being used is earlier than the first new source ID being used, and the second old source ID being used is earlier than the first source ID being used; the first old source ID, the second old source ID and the first new source ID are not used concurrently in time; when a link ID update occurs between the first node U01 and the second node U02 or between the first node U01 and the third node U03, a next one of the second old source ID, the first old source ID and the first new source ID will be employed.

In one subembodiment, the action of the first old source ID being used comprises that the third field or the fourth field in a header of an adaptation layer PDU comprises the first old source ID.

In one subembodiment, the action of the second old source ID being used comprises that the third field or the fourth field in a header of an adaptation layer PDU comprises the second old source ID.

In one subembodiment, the action of the first new source ID being used comprises that the third field or the fourth field in a header of an adaptation layer PDU comprises the first new source ID.

In one embodiment, the fifth MAC PDU group comprises a fifth adaptation layer PDU; the fifth adaptation layer PDU comprises a third PDCP PDU; when a header of the fifth adaptation layer PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID.

In one embodiment, the sixth MAC PDU group comprises a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

In one embodiment, when the fifth MAC PDU group is received, the fourth old ID is not updated as the fourth new ID yet.

In one embodiment, when the fifth MAC PDU group is received, the first node U01 has received the first message group.

In one embodiment, the first field in a MAC Header of any MAC PDU in the fifth MAC PDU group comprises 16 most significant bits (MSBs) in the fourth old ID.

In one embodiment, the first field in a MAC Header of any MAC PDU in the fifth MAC PDU group comprises 16 least significant bits (LSBs) in the fourth old ID.

In one embodiment, the second field in a MAC Header of any MAC PDU in the fifth MAC PDU group comprises 8 MSBs in the third old ID.

In one embodiment, the second field in a MAC Header of any MAC PDU in the fifth MAC PDU group comprises 8 LSBs in the third old ID.

In one embodiment, the first field in a MAC Header of any MAC PDU in the sixth MAC PDU group comprises 16 MSBs in the second new ID.

In one embodiment, the first field in a MAC Header of any MAC PDU in the sixth MAC PDU group comprises 16 LSBs in the second new ID.

In one embodiment, the second field in a MAC Header of any MAC PDU in the sixth MAC PDU group comprises 8 MSBs in the first new ID.

In one embodiment, the second field in a MAC Header of any MAC PDU in the sixth MAC PDU group comprises 8 LSBs in the first new ID.

In one embodiment, whether a header of an adaptation layer PDU transmitted to the second node U02 by the first node U01 uses the first new source ID is unrelated to a link layer ID comprised in a header of a MAC PDU received by the first node U01 from the third node U03.

In one embodiment, either the first field or the second field in a MAC Header of a MAC PDU in the seventh MAC PDU group comprises at least part of bits in a first ID; the seventh MAC PDU group comprises a seventh adaptation layer PDU, and the third field in a header of the seventh adaptation layer PDU comprises a second ID.

In one subembodiment, the first field in a MAC Header of any MAC PDU in the seventh MAC PDU group comprises 16 MSBs in the first ID.

In one subembodiment, the first field in a MAC Header of any MAC PDU in the seventh MAC PDU group comprises 16 LSBs in the first ID.

In one subembodiment, the second field in a MAC Header of any MAC PDU in the seventh MAC PDU group comprises 8 MSBs in the first ID.

In one subembodiment, the second field in a MAC Header of any MAC PDU in the seventh MAC PDU group comprises 8 LSBs in the first ID.

In one subembodiment, the second ID is one of a set of a first old source ID, a first old destination ID, a first new source ID and a first new destination ID.

In one subembodiment, the first ID is one of a set of a first old ID, a second old ID, a third old ID, a fourth old ID, a first new ID, a second new ID, a third new ID and a fourth new ID.

In one subembodiment, the first ID is a link layer ID.

In one embodiment, when the first ID belongs to a first ID set and a second ID belongs to a second ID set, or, when the first ID belongs to the second ID set and the second ID belongs to the first ID set, the first node U01 drops the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

In one embodiment, if the first ID and the second ID do not belong to the first ID set simultaneously, or belong to the second ID set simultaneously, the first node U01 drops the seventh adaptation layer PDU.

In one embodiment, upon dropping of the seventh adaptation layer PDU, the first node U01 sends out a request for link ID update.

In one embodiment, upon dropping of the seventh adaptation layer PDU, the first node U01 sends out a request for link update.

In one embodiment, upon dropping of the seventh adaptation layer PDU, the first node U01 sends out a request for source ID update and/or a request for destination ID update.

In one embodiment, upon dropping of the seventh adaptation layer PDU, the first node U01 releases a unicast link occupied by the seventh MAC PDU group.

In one embodiment, upon dropping of the seventh adaptation layer PDU, the first node U01 sends a message to indicate that the seventh adaptation layer PDU is discarded.

In one embodiment, upon dropping of the seventh adaptation layer PDU, the first node U01 sends a message to the seventh MAC PDU group, indicating that the seventh MAC PDU group is not correctly received.

### Embodiment 6

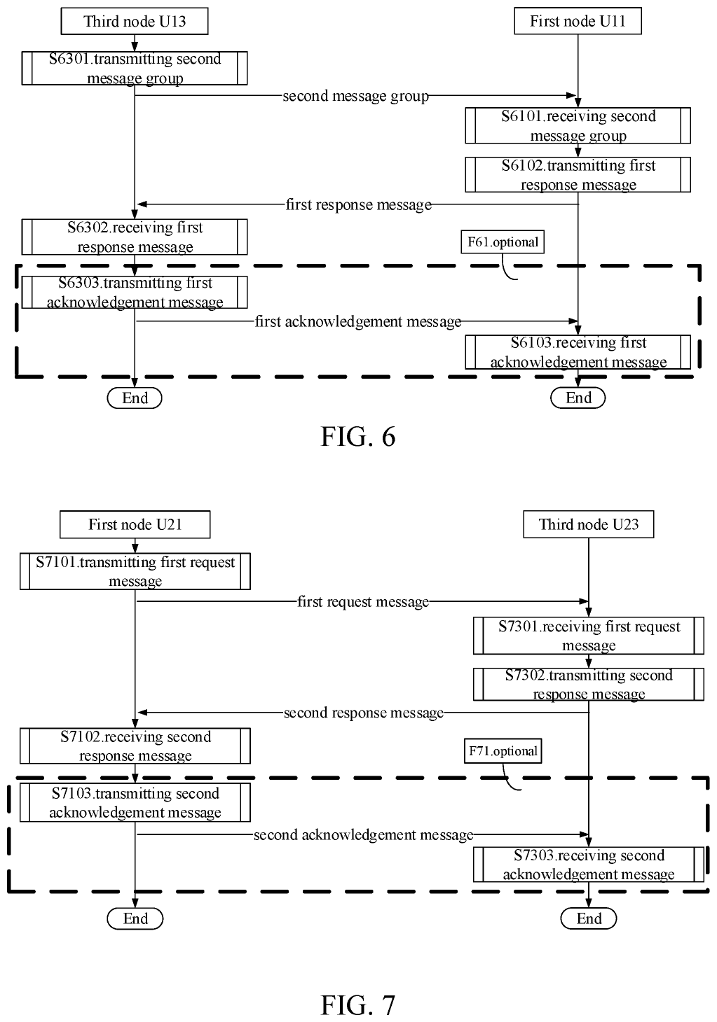

Embodiment 6 illustrates a flowchart of radio signal transmission according to one embodiment of the present disclosure, as shown in FIG. 6. In FIG. 6, U11 corresponds to the first node in the present disclosure, and U13 corresponds to the third node in the present disclosure; it should be particularly noted that the sequence illustrated in this figure does not set any limit on the order of signal transmissions and implementations in the present disclosure. Since the Embodiment 6 is derived from the Embodiment 5, whatever necessary steps that are not illustrated in details herein can be found in the Embodiment 5. In Embodiment 6, steps marked by the box F61 are optional.

The first node U11 receives a second message group in step S6101; transmits a first response message in step S6102; and receives a first acknowledgement message in step S6103.

The third node U13 transmits a second message group in step S6301; receives a first response message in step S6302; and transmits a first acknowledgement message in step S6303.

In one embodiment, the second message group indicates a fourth new ID and a first new destination ID; upon reception of the second message group, the first node U11 transmits a first response message, the first response message comprising the third new ID; when the first response message is transmitted, the first node U11 updates the fourth old ID as the fourth new ID.

In one embodiment, the first response message being transmitted is used to trigger the fourth old ID being updated as the fourth new ID.

In one embodiment, the first acknowledgement message is used to acknowledge the first response message.

In one embodiment, the first node U11 is a UE.

In one embodiment, the first node U11 is a relay.

In one subembodiment, the first node U11 is a UE with the relay function.

In one subembodiment, the first node U11 is a L2 relay.

In one embodiment, the third node U13 is a remote UE, as illustrated in Embodiment 6, the U13 is a target/destination UE.

In one embodiment, there is a node other than the first node U11 and the third node U13 that is in communication with the third node U13 through the first node U11.

In one embodiment, PC5 connection is established between the first node U11 and the third node U13.

In one embodiment, the first node U11 and the third node U13 are in communication through a unicast link.

In one embodiment, there is an RLC Bearer between the first node U11 and the third node U13.

In one embodiment, each message comprised in the second message group is a PC5-S message.

In one embodiment, each message comprised in the second message group is a PC5-RRC message.

In one embodiment, the second message group comprises both PC5-RRC message(s) and PC5-S message(s).

In one embodiment, messages in the second message group share a same transmitter.

In one embodiment, messages in the second message group are transmitted by different transmitters.

In one embodiment, transmitters for messages in the second message group are a source UE and a destination UE, respectively.

In one subembodiment, in the second message group, the message sent from the source UE is a PC5-S message, while the message sent from the target UE is a PC5-RRC message.

In one embodiment, at least one message in the second message group is generated by a message sent by a node which is relayed by the first node U11 and in communication with the third node U13.

In one embodiment, at least one field in at least one message in the second message group is generated by a message sent by a node which is relayed by the first node U11 and in communication with the third node U13.

In one embodiment, at least one field in at least one message in the second message group is indicated by a message sent by a node which is relayed by the first node U11 and in communication with the third node U13.

In one embodiment, the second message group comprises S2 message(s), where S2 is a positive integer.

In one embodiment, the second message group comprises DIRECT LINK IDENTIFIER UPDATE REQUEST.

In one embodiment, the second message group comprises DIRECT LINK IDENTIFIER UPDATE ACK.

In one embodiment, the second message group comprises DIRECT LINK IDENTIFIER UPDATE ACCEPT.

In one embodiment, the second message group comprises DIRECT LINK ESTABLISHMENT REQUEST.

In one embodiment, the second message group comprises DIRECT LINK ESTABLISHMENT ACCEPT.

In one embodiment, the second message group comprises DIRECT LINK MODIFICATION REQUEST.

In one embodiment, the second message group comprises DIRECT LINK MODIFICATION ACCEPT.

In one embodiment, the second message group comprises RRCReconfigurationSidelink.

In one embodiment, the second message group comprises RRCConnectionReconfigurationSidelink.

In one embodiment, the fourth new ID and the first new destination ID are carried by different messages in the second message group.

In one embodiment, the fourth new ID and the first new destination ID are carried by a same message in the second message group.

In one embodiment, when the second message group comprises DIRECT LINK IDENTIFIER UPDATE REQUEST, the first response message comprises DIRECT LINK IDENTIFIER UPDATE ACCEPT, and the first acknowledgement message comprises DIRECT LINK IDENTIFIER UPDATE ACK.

In one embodiment, when the second message group comprises DIRECT LINK ESTABLISHMENT REQUEST, the first response message comprises DIRECT LINK ESTABLISHMENT ACCEPT.

In one embodiment, when the second message group comprises DIRECT LINK MODIFICATION REQUEST, the first response message comprises DIRECT LINK MODIFICATION ACCEPT.

In one embodiment, when the second message group comprises RRCReconfigurationSidelink, the first response message comprises RRCReconfigurationCompleteSidelink.

In one embodiment, the first new destination ID is determined by an application ID.

In one subembodiment, the first new destination ID is an application ID.

In one subembodiment, the first new destination ID is partial bits comprised in an application ID.

In one subembodiment, the first new destination ID is comprised of partial bits comprised in an application ID and partial bits comprised in a link layer ID.

In one embodiment, the first new destination ID is an application identifier.

In one embodiment, the first new destination ID is an app ID.

In one embodiment, the first new destination ID is determined by an application layer ID.

In one embodiment, the first new destination ID is an application layer ID.

In one embodiment, the first new destination ID is partial bits in an application layer ID.

In one embodiment, the first new destination ID is at least partial bits or all bits comprised in an application layer ID of the third node U13.

In one embodiment, the first new destination ID is comprised of partial bits in an application layer ID and partial bits in a link layer ID.

In one embodiment, the first new destination ID is comprised of partial bits in an application layer ID and partial bits in the first new ID.

In one embodiment, the first new destination ID is an identity of a node other than the first node U11.

In one embodiment, the first new destination ID is an identity of a destination UE.

In one embodiment, the first new destination ID is an RNTI.

In one subembodiment, the first new destination ID is an RNTI of a node other than the first node U11.

In one subembodiment, the first new destination ID is an RNTI of a destination node.

In one subembodiment, the first new destination ID is an RNTI of the third node U13.

In one embodiment, the first new destination ID is an identity of a transmitter transmitting the second message group.

In one embodiment, the first new destination ID is an identity of a unicast link between a destination UE and the first node U11.

In one embodiment, the first new destination ID is a unicast link identifier.

In one embodiment, the first new destination ID comprises at least part of bits in an RNTI and at least part of bits in a link layer ID.

In one embodiment, the first new destination ID comprises at least part of bits in an RNTI and at least part of bits in the first new ID.

In one embodiment, the first new destination ID comprises at least part of bits in an RNTI and at least part of bits in an application ID.

In one embodiment, the first new destination ID comprises at least part of bits in an RNTI and at least part of bits in an application layer ID.

In one embodiment, the first new destination ID comprises an IP address and/or a port number.

In one embodiment, the first new destination ID comprises partial bits in an IP address.

In one embodiment, the first new destination ID comprises partial bits in an IP address of a destination UE.

In one embodiment, the action that the first node U11 updates the fourth old ID as the fourth new ID has the following meaning: the second field in a MAC Header of a MAC PDU transmitted by the first node U11 comprises at least partial bits in the fourth new ID and no longer comprises the fourth old ID.

In one embodiment, the action that the first node U11 updates the fourth old ID as the fourth new ID has the following meaning: the second field in a MAC Header of a MAC PDU transmitted by the first node U11 comprises 8 MSBs in the fourth new ID and no longer comprises the fourth old ID.

### Embodiment 7

Embodiment 7 illustrates a flowchart of radio signal transmission according to one embodiment of the present disclosure, as shown in FIG. 7. In FIG. 7, U21 corresponds to the first node in the present disclosure, and U23 corresponds to the third node in the present disclosure; it should be particularly noted that the sequence illustrated in this figure does not set any limit on the order of signal transmissions and implementations in the present disclosure. Since the Embodiment 7 is derived from the Embodiment 5, whatever necessary steps that are not illustrated in details herein can be found in the Embodiment 5. In Embodiment 7, steps marked by the box F71 are optional.

The first node U21 transmits a first request message in step S7101; receives a second response message in step S7102; and transmits a second acknowledgement message in step S7103.

The third node U23 receives a first request message in step S7301; transmits a second response message in step S7302; and receives a second acknowledgement message in step S7303.

In one embodiment, the first request message comprises the third new ID; the third request message is used for requesting a link layer ID update; the second response message is used for acceptance of the first request message; upon reception of the second response message, the first node U21 transmits a second acknowledgement message, the second acknowledgement message being used for acknowledgement of the second response message; when the second acknowledgement message is sent out, the first node 21 updates the fourth old ID as the fourth new ID.

In one embodiment, the first request message comprises the third new ID; the third request message is used for requesting a link layer ID update; the second response message is used for acceptance of the first request message; when the second acknowledgement message is sent out, the first node 21 updates the fourth old ID as the fourth new ID.

In one embodiment, reception of the second response message is used to trigger the fourth old ID being updated as the fourth new ID.

In one embodiment, transmission of the second acknowledgement message is used to trigger the fourth old ID being updated as the fourth new ID.

In one embodiment, the first node U21 is a UE.

In one embodiment, the first node U21 is a relay.

In one subembodiment, the first node U21 is a UE with the relay function.

In one subembodiment, the first node U21 is a L2 relay.

In one embodiment, the third node U23 is a remote UE, as illustrated in Embodiment 7, the U23 is a target/destination UE.

In one embodiment, there is a node other than the first node U21 and the third node U23 that is in communication with the third node U23 through the first node U21.

In one embodiment, PC5 connection is established between the first node U21 and the third node U23.

In one embodiment, the first node U21 and the third node U23 are in communication through a unicast link.

In one embodiment, there is an RLC Bearer between the first node U21 and the third node U23.

In one embodiment, the first request message comprises DIRECT LINK IDENTIFIER UPDATE REQUEST.

In one embodiment, the first request message comprises DIRECT LINK IDENTIFIER UPDATE ACK.

In one embodiment, the first request message comprises DIRECT LINK IDENTIFIER UPDATE ACCEPT.

In one embodiment, the first request message comprises DIRECT LINK ESTABLISHMENT REQUEST.

In one embodiment, the first request message comprises DIRECT LINK ESTABLISHMENT ACCEPT.

In one embodiment, the first request message comprises DIRECT LINK MODIFICATION REQUEST.

In one embodiment, the first request message comprises DIRECT LINK MODIFICATION ACCEPT.

In one embodiment, the first request message comprises RRCReconfigurationSidelink.

In one embodiment, the first request message comprises RRCConnectionReconfigurationSidelink.

In one embodiment, the first request message comprises a third new ID.

In one embodiment, the first request message comprises a third new ID rather than the first new destination ID.

In one embodiment, the second response message comprises the first new destination ID.

In one embodiment, the second response message comprises the fourth new ID.

In one embodiment, when the first request message comprises DIRECT LINK IDENTIFIER UPDATE REQUEST, the second response message comprises DIRECT LINK IDENTIFIER UPDATE ACCEPT, and the second acknowledgement message comprises DIRECT LINK IDENTIFIER UPDATE ACK.

In one embodiment, when the first request message comprises DIRECT LINK ESTABLISHMENT REQUEST, the second response message comprises DIRECT LINK ESTABLISHMENT ACCEPT.

In one embodiment, when the first request message comprises DIRECT LINK MODIFICATION REQUEST, the second response message comprises DIRECT LINK MODIFICATION ACCEPT.

In one embodiment, when the first request message comprises RRCReconfigurationSidelink, the second response message comprises RRCReconfigurationCompleteSidelink.

In one embodiment, reception of the first message group is used to trigger the first node U21 transmitting the first request message.

In one embodiment, the action that the first node U21 updates the fourth old ID as the fourth new ID has the following meaning: the second field in a MAC Header of a MAC PDU transmitted by the first node U21 comprises at least partial bits in the fourth new ID and no longer comprises the fourth old ID.

In one subembodiment, the first field in a MAC Header of a MAC PDU transmitted by the first node U21 comprises at least partial bits in the third new ID and no longer comprises the third old ID.

In one embodiment, the action that the first node U21 updates the fourth old ID as the fourth new ID has the following meaning: the second field in a MAC Header of a MAC PDU transmitted by the first node U21 comprises 8 MSBs in the fourth new ID and no longer comprises the fourth old ID.

In one subembodiment, the first field in a MAC Header of a MAC PDU transmitted by the first node U21 comprises 16 MSBs in the third new ID and no longer comprises the third old ID.

In one embodiment, upon reception of the first message group, the first node U21 transmits the first request message.

### Embodiment 8

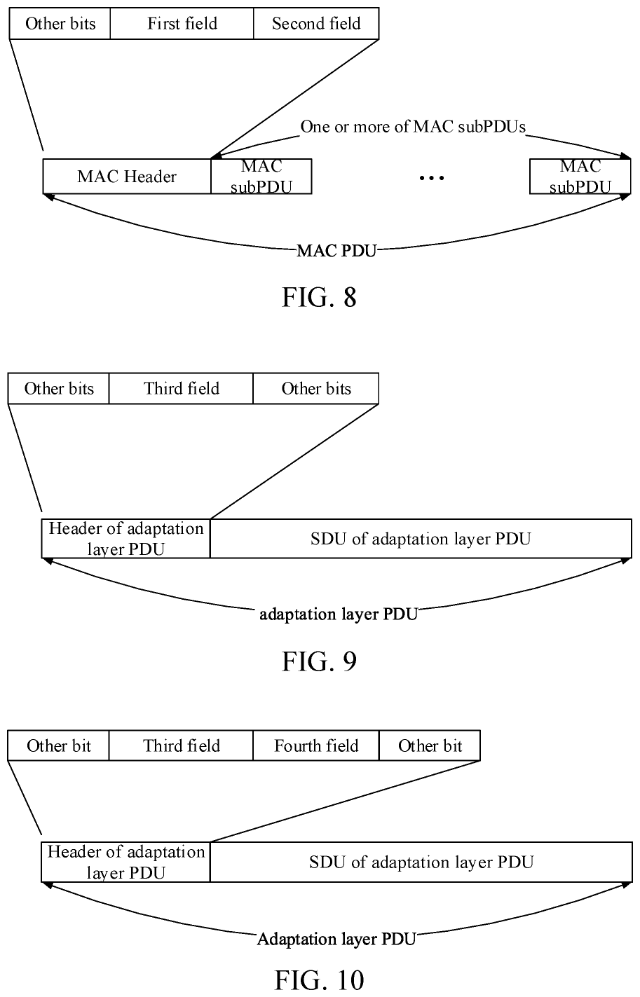

Embodiment 8 illustrates a schematic diagram of a MAC PDU according to one embodiment of the present disclosure, as shown in FIG. 8.

In Embodiment 8, a MAC PDU is comprised of one MAC Header and at least one MAC subPDU; the MAC Header comprises a first field, a second field and other bits.

In one embodiment, the MAC PDU is transmitted on a SideLink Shared CHannel (SL-SCH).

In one embodiment, the number of bits comprised in the MAC Header is fixed.

In one embodiment, the number of bits comprised in the MAC Header is 32.

In one embodiment, the MAC Header is a SL-SCH MAC subheader.

In one embodiment, the other bits comprise 5 fields, i.e., V, R, R, R and R, with the numbers of bits comprised respectively being 4, 1, 1, 1, and 1.

In one embodiment, the first field and the second field respectively comprise 16 bits and 8 bits.

In one embodiment, the first field in the MAC Header and the second field in the MAC Header are respectively a SRC field and a DST field.

In one embodiment, each MAC subPDU is comprised of a MAC subheader and a MAC SDU, and the MAC subheader in each MAC subPDU comprises a Logical Channel IDentifier (LCD) field, the LCD field indicating a channel identity of a logical channel for a corresponding MAC SDU.

In one embodiment, the LCD field comprises 5 bits.

In one embodiment, the LCD field comprises 6 bits.

In one embodiment, each MAC PDU is allowed to further comprise padding bits.

In one embodiment, a MAC subPDU comprises an RLC PDU.

In one embodiment, a MAC subPDU comprises a MAC CE.

In one embodiment, the MAC PDU in FIG. 8 is a MAC PDU in the first MAC PDU group in the present disclosure.

In one subembodiment, the first MAC PDU at least comprises a first MAC subPDU.

In one embodiment, the MAC PDU in FIG. 8 is a MAC PDU in the second MAC PDU group in the present disclosure.

In one subembodiment, the first MAC PDU at least comprises a second MAC subPDU.

In one embodiment, the MAC PDU in FIG. 8 is a MAC PDU in the third MAC PDU group in the present disclosure.

In one subembodiment, the first MAC PDU at least comprises a third MAC subPDU.

In one embodiment, the MAC PDU in FIG. 8 is a MAC PDU in the fourth MAC PDU group in the present disclosure.

In one subembodiment, the first MAC PDU at least comprises a fourth MAC subPDU.

In one embodiment, the MAC PDU in FIG. 8 is a MAC PDU in the fifth MAC PDU group in the present disclosure.

In one subembodiment, the first MAC PDU at least comprises a fifth MAC subPDU.

In one embodiment, the MAC PDU in FIG. 8 is a MAC PDU in the sixth MAC PDU group in the present disclosure.

In one subembodiment, the first MAC PDU at least comprises a sixth MAC subPDU.

In one embodiment, the MAC PDU in FIG. 8 is a MAC PDU in the seventh MAC PDU group in the present disclosure.

In one subembodiment, the first MAC PDU at least comprises a seventh MAC subPDU.

### Embodiment 9

Embodiment 9 illustrates a schematic diagram of an adaptation layer PDU according to one embodiment of the present disclosure, as shown in FIG. 9.

The adaptation layer PDU in Embodiment 9 is generated or received by the sublayer AP308 or the sublayer AP358 in Embodiment 3.

The adaptation layer PDU in Embodiment 9 comprises a header of the adaptation layer PDU and an SDU carried by the adaptation layer PDU; the adaptation layer PDU is also potentially carrying padding; other bits in FIG. 9 do not comprise the fourth field in the header of the adaptation layer PDU in the present disclosure.

In one embodiment, the header of the adaptation layer PDU comprises a third field.

In one embodiment, some other bits can be comprised, optionally, before the third field comprised in the header of the adaptation layer PDU.

In one embodiment, some other bits can be comprised, optionally, after the third field comprised in the header of the adaptation layer PDU.

In one embodiment, the third field comprised in the header of the adaptation layer PDU received by the first node comprises an identity of a source UE.

In one embodiment, the third field comprised in the header of the adaptation layer PDU transmitted by the first node comprises an identity of a destination UE.

In one embodiment, the third field comprised in the header of the adaptation layer PDU comprises 8 bits.

In one embodiment, the third field comprised in the header of the adaptation layer PDU comprises 16 bits.

In one embodiment, the third field comprised in the header of the adaptation layer PDU comprises 24 bits.

In one embodiment, the third field comprised in the header of the adaptation layer PDU comprises 32 bits.

In one embodiment, the SDU in the adaptation layer PDU comprises a first PDCP PDU.

In one embodiment, the SDU in the adaptation layer PDU comprises a second PDCP PDU.

In one embodiment, the SDU in the adaptation layer PDU comprises a third PDCP PDU.

In one embodiment, the adaptation layer PDU in FIG. 9 is the first adaptation layer PDU in the present disclosure.

In one embodiment, the adaptation layer PDU in FIG. 9 is the second adaptation layer PDU in the present disclosure.

In one embodiment, the adaptation layer PDU in FIG. 9 is the third adaptation layer PDU in the present disclosure.

In one embodiment, the adaptation layer PDU in FIG. 9 is the fourth adaptation layer PDU in the present disclosure.

In one embodiment, the adaptation layer PDU in FIG. 9 is the fifth adaptation layer PDU in the present disclosure.

In one embodiment, the adaptation layer PDU in FIG. 9 is the sixth adaptation layer PDU in the present disclosure.

In one embodiment, the adaptation layer PDU in FIG. 9 is the seventh adaptation layer PDU in the present disclosure.

### Embodiment 10

Embodiment 10 illustrates a schematic diagram of an adaptation layer PDU according to one embodiment of the present disclosure, as shown in FIG. 10.

The adaptation layer PDU in Embodiment 10 is generated or received by the sublayer AP308 or the sublayer AP358 in Embodiment 3.

The adaptation layer PDU in Embodiment 10 comprises a header of the adaptation layer PDU and an SDU carried by the adaptation layer PDU; the adaptation layer PDU is also potentially carrying padding.

In one embodiment, the header of the adaptation layer PDU comprises a third field and a fourth field.

In one embodiment, some other bits can be comprised, optionally, before the third field comprised in the header of the adaptation layer PDU.

In one embodiment, some other bits can be comprised, optionally, after the fourth field comprised in the header of the adaptation layer PDU.

In one embodiment, though not shown in FIG. 10, some other bits can be comprised, optionally, between the third field and the fourth field comprised in the header of the adaptation layer PDU.

In one embodiment, the third field comprised in the header of the adaptation layer PDU received by the first node comprises an identity of a source UE; the fourth field comprised in the header of the adaptation layer PDU received by the first node comprises an identity of a destination UE.

In one embodiment, the third field comprised in the header of the adaptation layer PDU transmitted by the first node comprises an identity of a source UE; the fourth field comprised in the header of the adaptation layer PDU transmitted by the first node comprises an identity of a destination UE.

In one embodiment, the third field comprised in the header of the adaptation layer PDU comprises 8 bits.

In one embodiment, the third field comprised in the header of the adaptation layer PDU comprises 16 bits.

In one embodiment, the third field comprised in the header of the adaptation layer PDU comprises 24 bits.

In one embodiment, the third field comprised in the header of the adaptation layer PDU comprises 32 bits.

In one embodiment, the fourth field comprised in the header of the adaptation layer PDU comprises 8 bits.

In one embodiment, the fourth field comprised in the header of the adaptation layer PDU comprises 16 bits.

In one embodiment, the fourth field comprised in the header of the adaptation layer PDU comprises 24 bits.

In one embodiment, the fourth field comprised in the header of the adaptation layer PDU comprises 32 bits.

In one embodiment, the fourth field comprised in the header of the adaptation layer PDU and the third field comprised in the header of the adaptation layer PDU comprise equal numbers of bits.

In one embodiment, the fourth field comprised in the header of the adaptation layer PDU and the third field comprised in the header of the adaptation layer PDU comprise different numbers of bits.

In one embodiment, the SDU in the adaptation layer PDU comprises a first PDCP PDU.

In one embodiment, the SDU in the adaptation layer PDU comprises a second PDCP PDU.

In one embodiment, the SDU in the adaptation layer PDU comprises a third PDCP PDU.

In one embodiment, the adaptation layer PDU in FIG. 10 is the first adaptation layer PDU in the present disclosure.

In one embodiment, the adaptation layer PDU in FIG. 10 is the second adaptation layer PDU in the present disclosure.

In one embodiment, the adaptation layer PDU in FIG. 10 is the third adaptation layer PDU in the present disclosure.

In one embodiment, the adaptation layer PDU in FIG. 10 is the fourth adaptation layer PDU in the present disclosure.

In one embodiment, the adaptation layer PDU in FIG. 10 is the fifth adaptation layer PDU in the present disclosure.

In one embodiment, the adaptation layer PDU in FIG. 10 is the sixth adaptation layer PDU in the present disclosure.

In one embodiment, the adaptation layer PDU in FIG. 10 is the seventh adaptation layer PDU in the present disclosure.

### Embodiment 11

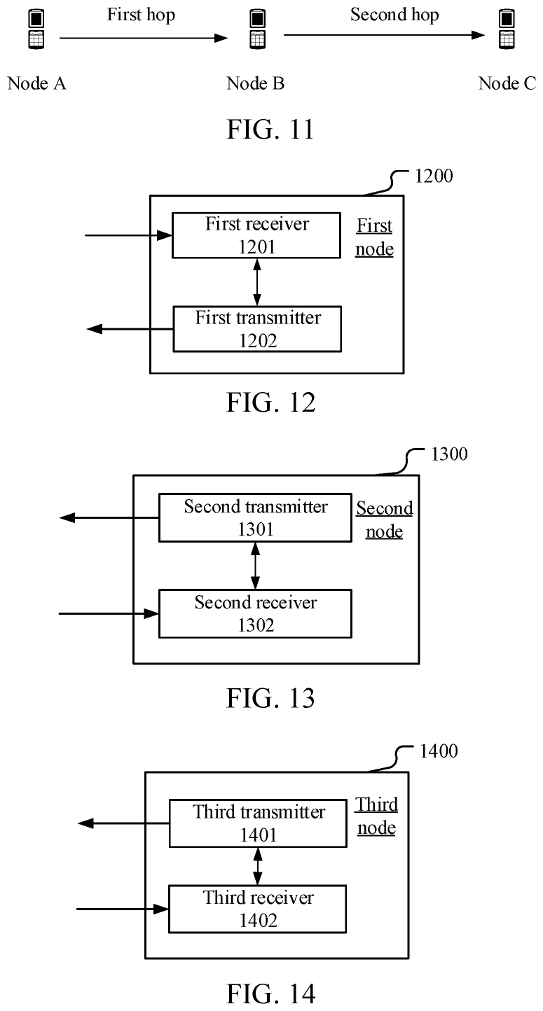

Embodiment 11 illustrates a schematic diagram of a topological structure according to one embodiment of the present disclosure, as shown in FIG. 11.

In Embodiment 11, a node A corresponds to the second node in the present disclosure; a node B corresponds to the first node in the present disclosure; a node C corresponds to the third node in the present disclosure

In Embodiment 11, the node A transmits data to the node C through the node B; the node B is a relay; in communications between the node A and the node C, a link from the node A to the node B is a first hop, and a link from the node B to the node C is a second hop.

In one embodiment, the node B receives data transmitted from the node A by the first hop, and then forwards the data received from the node A by the second hop.

In one embodiment, the first hop corresponds to a unicast link.

In one embodiment, the second hop corresponds to a unicast link.

In one embodiment, the first MAC PDU group is data transmitted by the node A by the first hop.

In one embodiment, the second MAC PDU group is data transmitted by the node B by the second hop.

In one embodiment, the first field in a MAC Header of a MAC PDU transmitted on the first hop comprises at least partial bits in the first new ID, and the second field comprises at least partial bits in the second new ID.

In one embodiment, the first field in a MAC Header of a MAC PDU transmitted on the first hop comprises at least partial bits in the first old ID, and the second field comprises at least partial bits in the second old ID.

In one embodiment, the first field in a MAC Header of a MAC PDU transmitted on the second hop comprises at least partial bits in the third new ID, and the second field comprises at least partial bits in the fourth new ID.

In one embodiment, the first field in a MAC Header of a MAC PDU transmitted on the second hop comprises at least partial bits in the third old ID, and the second field comprises at least partial bits in the fourth old ID.

In one embodiment, the third field in a header of an adaptation layer PDU comprised in a MAC PDU transmitted on the first hop comprises the first old source ID; and the fourth field in a header of an adaptation layer PDU comprised in a MAC PDU transmitted on the first hop comprises the first old destination ID.

In one embodiment, the third field in a header of an adaptation layer PDU comprised in a MAC PDU transmitted on the first hop comprises the first new source ID; and the fourth field in a header of an adaptation layer PDU comprised in a MAC PDU transmitted on the first hop comprises the first new destination ID.

In one embodiment, the third field in a header of an adaptation layer PDU comprised in a MAC PDU transmitted on the second hop comprises the first old source ID; and the fourth field in a header of an adaptation layer PDU comprised in a MAC PDU transmitted on the second hop comprises the first old destination ID.

In one embodiment, the third field in a header of an adaptation layer PDU comprised in a MAC PDU transmitted on the second hop comprises the first new source ID; and the fourth field in a header of an adaptation layer PDU comprised in a MAC PDU transmitted on the second hop comprises the first new destination ID.

In one embodiment, when a header of an adaptation layer PDU comprised in a MAC PDU transmitted on the first hop does not comprise the fourth field, the third field in the header of the adaptation layer PDU comprised in a MAC PDU transmitted on the first hop comprises the first old destination ID.

In one embodiment, when a header of an adaptation layer PDU comprised in a MAC PDU transmitted on the first hop does not comprise the fourth field, the third field in the header of the adaptation layer PDU comprised in a MAC PDU transmitted on the first hop comprises the first new destination ID.

In one embodiment, when a header of an adaptation layer PDU comprised in a MAC PDU transmitted on the second hop does not comprise the fourth field, the third field in the header of the adaptation layer PDU comprised in a MAC PDU transmitted on the second hop comprises the first old source ID.

In one embodiment, when a header of an adaptation layer PDU comprised in a MAC PDU transmitted on the second hop does not comprise the fourth field, the third field in the header of the adaptation layer PDU comprised in a MAC PDU transmitted on the second hop comprises the first new source ID.

In one embodiment, a link layer ID update of the first hop and a link layer ID update of the second hop are mutually independent.

In one embodiment, the first message group comprises the second message group.

In one subembodiment, a transmitter transmitting the first message group is a node A.

In one subembodiment, the first field in a MAC Header of a MAC PDU bearing the first message group comprises at least part of bits in the first old ID; the second field in a MAC Header of a MAC PDU bearing the first message group comprises at least part of bits in the second old ID.

In one subembodiment, a receiver receiving the first response message is a node C.

In one subembodiment, the first field in a MAC Header of a MAC PDU bearing the first response message comprises at least part of bits in the third old ID; the second field in a MAC Header of a MAC PDU bearing the first response message comprises at least part of bits in the fourth old ID.

In one subembodiment, the first field in a MAC Header of a MAC PDU bearing the first response message comprises at least part of bits in the third new ID; the second field in a MAC Header of a MAC PDU bearing the first response message comprises at least part of bits in the fourth new ID.

In one embodiment, a header of an adaptation layer PDU transmitted on the first hop comprises the first new source ID; a header of an adaptation layer PDU transmitted on the second hop comprises the first old source ID.

In one embodiment, a header of an adaptation layer PDU transmitted on the first hop comprises the first new source ID; a header of an adaptation layer PDU transmitted on the second hop comprises the first old destination ID.

In one embodiment, a header of an adaptation layer PDU transmitted on the first hop comprises the first new destination ID; a header of an adaptation layer PDU transmitted on the second hop comprises the first old source ID.

In one embodiment, a header of an adaptation layer PDU transmitted on the first hop comprises the first new destination ID; a header of an adaptation layer PDU transmitted on the second hop comprises the first old destination ID.

In one embodiment, the node A transmits the third message group to the node C, the third message group indicating a first new source ID.

In one embodiment, the third message group comprises one message or multiple messages.

In one embodiment, the third message group comprises a PC5-RRC message.

In one embodiment, the third message group comprises a PC5-S message.

In one embodiment, the third message group comprises DIRECT LINK IDENTIFIER UPDATE REQUEST.

In one embodiment, the third message group comprises DIRECT LINK IDENTIFIER UPDATE ACK.

In one embodiment, the third message group comprises DIRECT LINK IDENTIFIER UPDATE ACCEPT.

In one embodiment, the third message group comprises DIRECT LINK ESTABLISHMENT REQUEST.

In one embodiment, the third message group comprises DIRECT LINK ESTABLISHMENT ACCEPT.

In one embodiment, the third message group comprises DIRECT LINK MODIFICATION REQUEST.

In one embodiment, the third message group comprises DIRECT LINK MODIFICATION ACCEPT.

In one embodiment, the third message group comprises RRCReconfigurationSidelink.

In one embodiment, the third message group comprises RRCConnectionReconfigurationSidelink.

### Embodiment 12

Embodiment 12 illustrates a structure block diagram of a processing device in a first node according to one embodiment of the present disclosure; as shown in FIG. 12. In FIG. 12, a processing device 1200 in a first node comprises a first receiver 1201 and a first transmitter 1202.

In Embodiment 12, the first receiver 1201 receives a first message group and a first MAC PDU group, the first message group indicating a first new source ID and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

the first transmitter 1202 transmits the second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the third field in a header of the first adaptation layer PDU comprises the first new source ID, and a fourth field in a header of the first adaptation layer PDU comprises a first new destination ID;

when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID.

In one embodiment, the first receiver 1201 receives a first signaling and a third MAC

PDU group; the first signaling indicates the first old source ID and a second old source ID; the first field in a MAC Header of any MAC PDU in the third MAC PDU group comprises at least part of bits in a first old ID; the second field in a MAC Header of any MAC PDU in the third MAC PDU group comprises at least part of bits in a second old ID; the third MAC PDU group comprises a third adaptation layer PDU; when a header of the third adaptation layer PDU comprises the fourth field, the third field in a header of the third adaptation layer PDU comprises the second old source ID and the fourth field in a header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU;

the first transmitter 1202 transmits a fourth MAC PDU group, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

In one embodiment, the first receiver 1201 receives a second message group; the second message group indicates a fourth new ID and a first new destination ID;

upon reception of the second message, the first transmitter 1202 transmits a first response message, the first response message comprising the third new ID; after the first response message is transmitted, the first transmitter 1202 updates the fourth old ID as the fourth new ID.

In one embodiment, the first transmitter 1202 transmits a first request message, the first request message comprising the third new ID; the third request message is used to request for a link layer ID update;

the first receiver 1201 receives a second response message, the second response message being used for acceptance of the first request message;

upon reception of the second response message, the first transmitter 1202 transmits a second acknowledgement message, the second acknowledgement message being used for acknowledgement of the second response message; soon after the second acknowledgement message is sent out, the first transmitter updates the fourth old ID as the fourth new ID.

In one embodiment, the first receiver 1201 receives a fifth MAC PDU group, the fifth MAC PDU group comprising a fifth adaptation layer PDU; the fifth adaptation layer PDU comprises a third PDCP PDU; when a header of the fifth adaptation layer PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID;

the first transmitter 1202 transmits a sixth MAC PDU group, the sixth MAC PDU group comprising a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

In one embodiment, the first receiver 1201 receives a seventh MAC PDU group, with either the first field or the second field in a MAC Header of any MAC PDU in the seventh MAC PDU group comprising at least part of bits in a first ID; the seventh MAC PDU group comprises a seventh adaptation layer PDU, and the third field in a header of the seventh adaptation layer PDU comprises a second ID;

when the first ID belongs to a first ID set and a second ID belongs to a second ID set, or, when the first ID belongs to the second ID set and the second ID belongs to the first ID set, the first receiver drops the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

In one embodiment, the first node is a UE.

In one embodiment, the first node is a terminal supporting large delay difference.

In one embodiment, the first node is a terminal supporting NTN.

In one embodiment, the first node is an aircraft.

In one embodiment, the first node is a vehicle-mounted terminal.

In one embodiment, the first node is a relay.

In one embodiment, the first node is a vessel.

In one embodiment, the first node is a IoT terminal.

In one embodiment, the first node is a terminal of Industrial Internet of Things (IIoT).

In one embodiment, the first node is a piece of equipment supporting transmission with low latency and high reliability.

In one embodiment, the first receiver 1201 comprises at least one of the antenna 460, the receiver 456, the receiving processor 452, the multi-antenna receiving processor, the controller/processor 490, the memory or the data source 480 in Embodiment 4.

In one embodiment, the first transmitter 1202 comprises at least one of the antenna 460, the transmitter 456, the transmitting processor 455, the multi-antenna transmitting processor, the controller/processor 490, the memory or the data source 480 in Embodiment 4.

### Embodiment 13

Embodiment 13 illustrates a structure block diagram of a processing device in a second node according to one embodiment of the present disclosure; as shown in FIG. 13. In FIG. 13, a processing device 1300 in a second node comprises a second transmitter 1301 and a second receiver 1302.

In Embodiment 13, the second transmitter 1301 transmits a first message group and a first MAC PDU group, the first message group indicating a first new source ID and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

a receiver of the first MAC PDU group transmits the second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the third field in a header of the first adaptation layer PDU comprises the first new source ID, and a fourth field in a header of the first adaptation layer PDU comprises a first new destination ID;

when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID.

In one embodiment, the second transmitter 1301 transmits a first signaling and a third MAC PDU group; the first signaling indicates the first old source ID and a second old source ID; the first field in a MAC Header of any MAC PDU in the third MAC PDU group comprises at least part of bits in a first old ID; the second field in a MAC Header of any MAC PDU in the third MAC PDU group comprises at least part of bits in a second old ID; the third MAC PDU group comprises a third adaptation layer PDU; when a header of the third adaptation layer PDU comprises the fourth field, the third field in a header of the third adaptation layer PDU comprises the second old source ID and the fourth field in a header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU;

the receiver of the first MAC PDU group transmits a fourth MAC PDU group, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

In one embodiment, the receiver of the first MAC PDU group receives a fifth MAC PDU group, the fifth MAC PDU group comprising a fifth adaptation layer PDU; the fifth adaptation layer PDU comprises a third PDCP PDU; when a header of the fifth adaptation layer PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID;

the second receiver 1302 receives a sixth MAC PDU group, the sixth MAC PDU group comprising a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

In one embodiment, the second transmitter 1301 transmits a third message group, the third message group indicating a first new source ID.

In one embodiment, the second receiver 1302 receives a seventh MAC PDU group, with either the first field or the second field in a MAC Header of any MAC PDU in the seventh MAC PDU group comprising at least part of bits in a first ID; the seventh MAC PDU group comprises a seventh adaptation layer PDU, and the third field in a header of the seventh adaptation layer PDU comprises a second ID;

when the first ID belongs to a first ID set and a second ID belongs to a second ID set, or, when the first ID belongs to the second ID set and the second ID belongs to the first ID set, the first receiver drops the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

In one embodiment, the second node is a satellite.

In one embodiment, the second node is a UE.

In one embodiment, the second node is a IoT node.

In one embodiment, the second node is a wearable node.

In one embodiment, the second receiver 1302 comprises at least one of the antenna 460, the receiver 456, the receiving processor 452, the multi-antenna receiving processor, the controller/processor 490, the memory or the data source 480 in Embodiment 4.

In one embodiment, the second transmitter 1301 comprises at least one of the antenna 460, the transmitter 456, the transmitting processor 455, the multi-antenna transmitting processor, the controller/processor 490, the memory or the data source 480 in Embodiment 4.

### Embodiment 14

Embodiment 14 illustrates a structure block diagram a processing device in a third node according to one embodiment of the present disclosure; as shown in FIG. 14. In FIG. 14, a processing device 1400 in a third node comprises a third transmitter 1401 and a third receiver 1402.

In Embodiment 14, a transmitter of the second MAC PDU group receives a first message group and a first MAC PDU group, the first message group indicating a first new source ID and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;

The third receiver 1402 receives the second MAC PDU group; the second MAC PDU group comprises a second adaptation layer PDU; the second adaptation layer PDU comprises the first PDCP PDU;

herein, when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

In one embodiment, the third field in a header of the first adaptation layer PDU comprises the first new source ID, and a fourth field in a header of the first adaptation layer PDU comprises a first new destination ID;

when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID.

In one embodiment, a transmitter of the second MAC PDU group receives a first signaling and a third MAC PDU group; the first signaling indicates the first old source ID and a second old source ID; the first field in a MAC Header of any MAC PDU in the third MAC PDU group comprises at least part of bits in a first old ID; the second field in a MAC Header of any MAC PDU in the third MAC PDU group comprises at least part of bits in a second old ID; the third MAC PDU group comprises a third adaptation layer PDU; when a header of the third adaptation layer PDU comprises the fourth field, the third field in a header of the third adaptation layer PDU comprises the second old source ID and the fourth field in a header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU;

the third receiver 1402 receives a fourth MAC PDU group, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

In one embodiment, the third transmitter 1401 transmits a second message group; the second message group indicates a fourth new ID and a first new destination ID;

The third receiver 1402 receives a first response message, the first response message being used to respond to the second message, the first response message comprising the third new ID; upon transmission of the first response message, the transmitter of the second MAC PDU updating the fourth old ID as the fourth new ID; the third transmitter 1401 transmits a first acknowledgement message, the first acknowledgement message being used to acknowledge the first response message, upon reception of the first acknowledgement message, updates the fourth old ID as the fourth new ID.

In one embodiment, the third receiver 1402 receives a first request message, the first request message comprising the third new ID; the third request message is used to request for a link layer ID update;

the third transmitter 1401 transmits a second response message, the second response message being used for acceptance of the first request message;

upon reception of the second response message, the third receiver 1402 receives a second acknowledgement message, the second acknowledgement message being used for acknowledgement of the second response message; soon after the second acknowledgement message is sent out, the transmitter of the second MAC PDU group, updating the fourth old ID as the fourth new ID; after the second acknowledgement message is received, update the fourth old ID as the fourth new ID.

In one embodiment, the third transmitter 1401 transmits a fifth MAC PDU group, the fifth MAC PDU group comprising a fifth adaptation layer PDU; the fifth adaptation layer PDU comprises a third PDCP PDU; when a header of the fifth adaptation layer PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID;

the transmitter of the second MAC PDU group, transmits a sixth MAC PDU group, the sixth MAC PDU group comprising a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

In one embodiment, the third receiver 1402 receives a seventh MAC PDU group, with either the first field or the second field in a MAC Header of any MAC PDU in the seventh MAC PDU group comprising at least part of bits in a first ID; the seventh MAC PDU group comprises a seventh adaptation layer PDU, and the third field in a header of the seventh adaptation layer PDU comprises a second ID;

when the first ID belongs to a first ID set and a second ID belongs to a second ID set, or, when the first ID belongs to the second ID set and the second ID belongs to the first ID set, drop the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

In one embodiment, the third receiver 1402 receives a third message group, the third message group indicating a first new source ID.

In one embodiment, the third node is a satellite.

In one embodiment, the third node is a UE.

In one embodiment, the third node is a IoT node.

In one embodiment, the third node is a wearable node.

In one embodiment, the third node is a IAB node.

In one embodiment, the third node is a relay.

In one embodiment, the third transmitter 1401 comprises at least one of the antenna 420, the transmitter 416, the transmitting processor 415, the multi-antenna transmitting processor, the controller/processor 440, the memory 430 in Embodiment 4.

In one embodiment, the third receiver 1402 comprises at least one of the antenna 420, the receiver 416, the receiving processor 412, the multi-antenna receiving processor, the controller/processor 440, the memory 430 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be implemented in the form of hardware, or in the form of software function modules. The present disclosure is not limited to any combination of hardware and software in specific forms. The UE and terminal in the present disclosure include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present disclosure includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment, eNB (LTE node B), test equipment like transceiving device simulating partial functions of base station or signaling tester.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, which receives a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;
a first transmitter, which transmits a second MAC PDU group; the second MAC PDU group comprises a second adaptation layer PDU; the second adaptation layer PDU comprises the first PDCP PDU;
wherein when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

2. The first node according to claim 1, wherein
the first node is in communications via a sidelink.

3. The first node according to claim 2, wherein
the link layer ID is comprised of 24 bits; a first field in a MAC Header of any MAC PDU in the first MAC PDU group comprises N1 bits in the first new ID; a second field in a MAC Header of any MAC PDU in the first MAC PDU group comprises N2 bits in the second new ID; a first field in a MAC Header of any MAC PDU in the second MAC PDU group comprises N3 bits in the third new ID; a second field in a MAC Header of any MAC PDU in the second MAC PDU group comprises N4 bits in the fourth new ID;
wherein one of N1 and N2 is equal to 8 and the other equal to 16; one of the N3 and N4 is equal to 8 and the other 16.

4. The first node according to claim 3, comprising:
the first transmitter, which transmits a first request message, the first request message comprising the third new ID; the third request message is used to request for a link layer ID update;
the first receiver, which receives a second response message, the second response message being used for acceptance of the first request message;
upon reception of the second response message, the first transmitter transmits a second acknowledgement message, the second acknowledgement message being used for acknowledgement of the second response message; soon after the second acknowledgement message is sent out, the first transmitter updates the fourth old ID as the fourth new ID.

5. The first node according to claim 4, wherein
the third field in a header of the first adaptation layer PDU comprises the first new source ID, and a fourth field in a header of the first adaptation layer PDU comprises a first new destination ID;
when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID.

6. The first node according to claim 5, wherein
the third field in the first adaptation layer PDU is used to indicate an ID of a generator of an SDU carried by the first adaptation layer PDU.

7. The first node according to claim 6, wherein
the first new source ID is generated by the first new ID; the first old source ID is generated by the first old ID.

8. The first node according to claim 2, wherein
the first receiver, which receives a first signaling and a third MAC PDU group; the first signaling indicates the first old source ID and a second old source ID; the first field in a MAC Header of any MAC PDU in the third MAC PDU group comprises at least part of bits in a first old ID; the second field in a MAC Header of any MAC PDU in the third MAC PDU group comprises at least part of bits in a second old ID; the third MAC PDU group comprises a third adaptation layer PDU; when a header of the third adaptation layer PDU comprises the fourth field, the third field in a header of the third adaptation layer PDU comprises the second old source ID and the fourth field in a header of the third adaptation layer PDU comprises the first old destination ID; when the header of the third adaptation layer PDU does not comprise the fourth field, the third field in the header of the third adaptation layer PDU comprises the first old destination ID; the third adaptation layer PDU comprises a second PDCP PDU;
the first transmitter, which transmits a fourth MAC PDU group, the first field in a MAC Header of any MAC PDU in the fourth MAC PDU group comprises at least part of bits in the third old ID; the second field in a MAC Header of any MAC PDU in the fourth MAC PDU group comprises at least part of bits in the fourth old ID; the fourth MAC PDU group comprises a fourth adaptation layer PDU; the third field in a header of the fourth adaptation layer PDU comprises the second old source ID; the fourth adaptation layer PDU comprises a second PDCP PDU.

9. The first node according to claim 8, comprising:
the first receiver, which receives a second message group; the second message group indicates a fourth new ID and a first new destination ID;
upon reception of the second message, the first transmitter transmits a first response message, the first response message comprising the third new ID; after the first response message is transmitted, the first transmitter updates the fourth old ID as the fourth new ID.

10. The first node according to claim 9, wherein
at least one field in at least one message in the second message group is generated by a message sent by a node which is relayed by the first node and in communication with a third node.

11. The first node according to claim 10, comprising:
the first receiver, which receives a fifth MAC PDU group, the fifth MAC PDU group comprising a fifth adaptation layer PDU; the fifth adaptation layer PDU comprises a third PDCP PDU; when a header of the fifth adaptation layer PDU comprises the fourth field, the fourth field in the header of the fifth adaptation layer PDU comprises the first old source ID; when a header of the fifth adaptation layer PDU does not comprise the fourth field, the third field in the header of the fifth adaptation layer PDU comprises the first old source ID; the second field in a MAC Header of any MAC PDU in the fifth MAC PDU group comprises at least part of bits in the third old ID; the first field in a MAC Header of any MAC PDU in the fifth MAC PDU group comprises at least part of bits in the fourth old ID;
the first transmitter, which transmits a sixth MAC PDU group, the sixth MAC PDU group comprising a sixth adaptation layer PDU; the sixth adaptation layer PDU comprises the third PDCP PDU; the third field in a header of the sixth adaptation layer PDU comprises a first new destination ID; when the header of the sixth adaptation layer PDU comprises the fourth field, the fourth field in the header of the sixth adaptation layer PDU comprises the first new source ID; the second field in a MAC Header of any MAC PDU in the sixth MAC PDU group comprises at least part of bits in the first new ID; the first field in a MAC Header of any MAC PDU in the sixth MAC PDU group comprises at least part of bits in the second new ID.

12. The first node according to claim 11, comprising:
the first receiver, which receives a seventh MAC PDU group, with either the first field or the second field in a MAC Header of any MAC PDU in the seventh MAC PDU group comprising at least part of bits in a first ID; the seventh MAC PDU group comprises a seventh adaptation layer PDU, and the third field in a header of the seventh adaptation layer PDU comprises a second ID;
when the first ID belongs to a first ID set and a second ID belongs to a second ID set, or, when the first ID belongs to the second ID set and the second ID belongs to the first ID set, the first receiver drops the seventh adaptation layer PDU; the first ID set is comprised of a first new ID, a second new ID, a third new ID, a fourth new ID, a first new source ID and a first new destination ID, while the second ID set is comprised of a first old ID, a second old ID, a third old ID, a fourth old ID, a first old source ID and a first old destination ID.

13. The first node according to claim 1, wherein
the third field in a header of the first adaptation layer PDU comprises the first new source ID, and a fourth field in a header of the first adaptation layer PDU comprises a first new destination ID;
when the fourth old ID is updated as the fourth new ID, the fourth field in a header of the second adaptation layer PDU comprises the first new destination ID rather than a first old destination ID; when the fourth old ID is not updated as the fourth new ID, the fourth field in a header of the second adaptation layer PDU comprises the first old destination ID rather than the first new destination ID; the third field in the first adaptation layer PDU is used to indicate an ID of a generator of an SDU carried by the first adaptation layer PDU.

14. The first node according to claim 1, wherein
the first new source ID is generated by the first new ID; the first old source ID is generated by the first old ID.

15. The first node according to claim 1, wherein
a request message for link update of a UE with the fourth old ID being received by the first node is used to trigger the fourth old ID being updated as the fourth new ID by the first node.

16. The first node according to claim 1, wherein
the first receiver, which receives a second message group; the second message group indicates a fourth new ID and a first new destination ID;
upon reception of the second message, the first transmitter transmits a first response message, the first response message comprising the third new ID; after the first response message is transmitted, the first transmitter updates the fourth old ID as the fourth new ID; at least one field in at least one message in the second message group is generated by a message sent by a node which is relayed by the first node and in communication with a third node.

17. A second node for wireless communications, comprising:
a second transmitter, which transmits a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;
a receiver of the first MAC PDU group transmitting a second MAC PDU group; the second MAC PDU group comprises a second adaptation layer PDU; the second adaptation layer PDU comprises the first PDCP PDU;
wherein when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.

18. A third node for wireless communications, comprising:
a transmitter of the second MAC PDU group, which receives a first message group and a first MAC PDU group, the first message group indicating a first new source identity (ID) and a first new ID; a first field in a MAC Header of any MAC PDU in the first MAC PDU group comprises at least part of bits in the first new ID; a second field in a MAC Header of any MAC PDU in the first MAC PDU group comprises at least part of bits in a second new ID; the first MAC PDU group comprises a first adaptation layer PDU, the first adaptation layer PDU comprising a first PDCP PDU;
a third receiver, which receives the second MAC PDU group; the second MAC PDU group comprises a second adaptation layer PDU; the second adaptation layer PDU comprises the first PDCP PDU;
wherein when a fourth old ID is updated as a fourth new ID, the first field in a MAC Header of any MAC PDU in the second MAC PDU group comprises at least part of bits in a third new ID, and the second field in a MAC Header of any MAC PDU in the second MAC PDU group comprises at least part of bits in the fourth new ID, and a third field in a header of the second adaptation layer PDU comprises the first new source ID rather than a first old source ID; when the fourth old ID is not updated as the fourth new ID, the first field in a MAC Header of any MAC PDU in the second MAC PDU group comprises at least part of bits in a third old ID; the second field in a MAC Header of any MAC PDU in the second MAC PDU group comprises at least part of bits in the fourth old ID, and the third field in a header of the second adaptation layer PDU comprises the first old source ID rather than the first new source ID; the first new ID, the second new ID, the third new ID, the third old ID, the fourth new ID and the fourth old ID are link layer IDs, respectively.
